(19) United States
(12) Patent Application Publication
(10) Pub. No.: US 2020/0113037 A1
(43) Pub. Date: Apr. 9, 2020

(54) PROBABILISTIC MODELS FOR BEAM, SPOT, AND LINE EMISSION FOR COLLIMATED X-RAY EMISSION

(71) Applicant: IH IP Holdings Limited, St. Helier (JE)

(72) Inventor: Peter L. Hagelstein, Carlisle, MA (US)

(21) Appl. No.: 16/703,924

(22) Filed: Dec. 5, 2019

Related U.S. Application Data
(63) Continuation of application No. PCT/US18/36063, filed on Jun. 5, 2018.
(60) Provisional application No. 62/516,604, filed on Jun. 7, 2017.
(60) Provisional application No. 62/515,393, filed on Jun. 5, 2017.

(51) Int. Cl. H05G 2/00

(52) U.S. Cl. CPC H05G 2/00

(57) ABSTRACT

An apparatus includes a driver for generating oscillations; and a medium comprising arranged nuclei configured to oscillate at one or more oscillating frequencies when the medium is driven by the driver, wherein nuclear electromagnetic quanta are down-converted to vibrational quanta; or vibrational quanta are up-converted to nuclear quanta; or nuclear excitation is transferred to other nuclei in the medium; or nuclear excitation is subdivided and transferred to other nuclei in the medium (thereby exciting them); or a combination of the above due to interaction between vibrational energy of the oscillating nuclei and the oscillating nuclei.

### CROSS-REFERENCE TO RELATED APPLICATIONS

This application is a continuation of International Application No. PCT/US18/36063, filed on Jun. 5, 2018, entitled “PROBABILISTIC MODELS FOR BEAM, SPOT, AND LINE EMISSION FOR COLLIMATED X-RAY EMISSION”, which claims priority to U.S. Provisional Patent Applications No. 62/515,393 filed on Jun. 5, 2017, and 62/516,604 filed on Jun. 7, 2017, the contents of which are incorporated by reference herein.

### BACKGROUND

Excess heat and other effects in glow discharge experiments were previously observed. For example, collimated X-ray emission has been observed near 1.5 keV. In order for such X-rays to be collimated, there may be an X-ray laser present, or a phased-array collimation effect may be produced by emitting dipoles that radiate in phase. Although there have been arguments made in support of an X-ray laser origin of the effect, a plausible mechanism has not been suggested, and such an approach suffers from short excited-state electronic lifetimes, high power requirements, and an incompatibility between the experimental geometry and the need for an elongated laser medium for beam formation.

Karabut and his coworkers at the Luch Institute reported the observation of excess heat and other anomalies in glow discharge experiments in the early 1990s. In subsequent experiments Karabut noticed that soft X-rays near 1.5 keV were emitted, and that they were collimated upward in his experiment normal to the cathode surface. This effect was studied and was found to be independent of the cathode metal (the effect was seen with Al, and with other metals through W), and to be independent of which discharge gas was used (collimated emission was seen with H2, D2, He, Ne, Ar and Xe).

### SUMMARY

This summary is provided to introduce in a simplified form concepts that are further described in the following detailed descriptions. This summary is not intended to identify key features or essential features of the claimed subject matter, nor is it to be construed as limiting the scope of the claimed subject matter.

In at least one embodiment, an apparatus inlcudes: a driver for generating oscillations; and a medium comprising arranged nuclei configured to oscillate at one or more oscillating frequencies when the medium is driven by the driver, wherein (1) nuclear electromagnetic quanta are down-converted to vibrational quanta; or (2) vibrational quanta are up-converted to nuclear quanta; or (3) nuclear excitation is transferred to other nuclei in the medium; or (4) nuclear excitation is subdivided and transferred to other nuclei in the medium (thereby exciting them); or (5) a combination of the above due to interaction between vibrational energy of the oscillating nuclei and the oscillating nuclei.

The oscillating nuclei may include stable nuclei that can be excited onto one or more unstable states, and wherein, when the vibrational quanta are up-converted, the vibrational energy excites the stable nuclei to the one or more unstable states from which the excited nuclei undergo nuclear decay.

When the vibrational quanta are down-converted, nuclear energy or electrical energy may be converted to vibrational energy of the oscillating nuclei.

Some of the oscillating nuclei may include excited nuclei whose excited states can be transferred to other oscillating nuclei in the medium, thereby elevating them from ground state to excited state while the original excited state nuclei fall to ground state.

The excitation transfer from excited nuclei to other nuclei may lead to a delocalization of radioactive emission from excited nuclei in the medium.

Some of the oscillating nuclei may include excited nuclei whose excited state energies are subdivided and transferred to other oscillating nuclei in the medium, thereby elevating them from ground state to excited state while the original excited state nuclei fall to ground state. In this case of subdivision, not the same energy is transferred from one excited nucleus to another nucleus (as with excitation transfer above) but fractions of the excited nucleus' energy are transferred from one excited nucleus to two or more other nuclei (with the sum of the subdivided excitation energy transferred to other nuclei being equal to or smaller than the energy of the originally excited nucleus and the differential energy being either absorbed or emitted by the lattice as phonons/vibrational energy).

The oscillations generated by the driver may be of one or more driving frequencies between 10 KHz and 50 THz.

The medium may include a solid or a liquid and the driver may be connected to a signal generator via an amplifier, the signal generator generating a signal of a selected frequency; wherein the signal generator, via the amplifier, applies a drive voltage to the driver and the driver induces oscillations of the nuclei in the medium due to a vibrational coupling.

The oscillations may be generated in other ways as long as (high energy) phonons are being created in the medium such as a transducer setup.

Oscillations may be generated through elastic and inelastic deformations or the relaxation of elastic and inelastic deformations such as a press or a clamping mechanism that applies pressure to a medium.

The clamping mechanism may include wood blocks being pressed against a metal plate which induces stresses on the metal lattice, wherein high frequency phonons are generated during the relaxation of the deformed lattices through both the metal lattice and the wood lattice which is coupled to the metal lattice, wherein the resulting phonons can then cause the described up-conversion, down-conversion, excitation transfer and subdivision effects, as described in any of the preceding claims.

The selected frequency may be set to be one half of a resonant frequency of the metal plate and wherein the resonant frequency of the metal plate is associated with a compressional or transverse vibrational mode of the metal plate.

The metal plate may be further attached to a resonator to arrange for a large number of nuclei to oscillate coherently.

The metal plate may be connected to a collector that collects the charges emitted by the vibrating metal plate.

The metal plate may be made of a metal selected from the group of copper, aluminum, nickel, titanium, palladium, tantalum, and tungsten.

The driver may be connected to a copper pole for support, wherein the length of the driver is between 0.20-0.30 inches and the diameter of the driver is between 0.7-0.8 inches, the thickness of the metal plate is between 70-80 microns, and the distance between the driver and the metal plate is between 10-100 microns.

The driver may be coated with Polyvinylidene Fluoride (PVDF) to prevent air breakdown, and wherein the distance between the driver and the metal plate is approximately 20 microns.

The oscillating nuclei may release phased-array emissions, which may be collimated, and may include X-rays.

The driver may include an ultrasound transducer.

The medium may include a metal plate where phonon energies from the ultrasound transducer are coupled to excite the oscillating nuclei.

A Co-57 source may be attached to a steel or iron plate, wherein the Co-57 provides excited nuclei whose excitation can be transferred to unexcited iron nuclei in the oscillating medium, wherein other sources and medium materials are used as well.

In at least one embodiment, a method or process includes: oscillating at one or more oscillating frequencies when the medium is driven by the driver, wherein (1) nuclear electromagnetic quanta are down-converted to vibrational quanta; or (2) vibrational quanta are up-converted to nuclear quanta; or (3) nuclear excitation is transferred to other nuclei in the medium; or (4) nuclear excitation is subdivided and transferred to other nuclei in the medium (thereby exciting them); or (5) a combination of the above;—due to interaction between vibrational energy of the oscillating nuclei and the oscillating nuclei.

### BRIEF DESCRIPTION OF THE DRAWINGS

The previous summary and the following detailed descriptions are to be read in view of the drawings, which illustrate particular exemplary embodiments and features as briefly described below. The summary and detailed descriptions, however, are not limited to only those embodiments and features explicitly illustrated.

FIG. 1 is a schematic of a model according to at least one embodiment, in which phase coherent dipoles are positioned randomly within an emitting area of the cathodes surface, and radiate to form a beam if the emitting dipoles are in phase and have a sufficiently high density.

FIG. 2 shows a beam at an image plane located a Z=25 cm in the case of a dipole density of 1.0E9 cm⁻², localized in a circle of radius 100 micron and marked in the center is a circle of radius 100 microns.

FIG. 3 is a plot of expectation value as a function of dipole density.

FIG. 4 shows a beam at an image plane located a Z=25 cm in the case of a dipole density of 5.0E7 cm⁻², localized in a marked circle of radius 100 μm.

FIG. 5 is a histogram of intensity for a speckle pattern with the weak beam of FIG. 4

FIG. 6 is a histogram of intensity for speckle pattern with the beam of FIG. 2 formed at an emitting dipole density of 1.0E9 dipoles/cm².

FIG. 7 shows a partially focused beam at an image plane located a Z=25 cm in the case of a dipole density of 1.0E9 cm⁻², with a marked circle of radius 100 μm.

FIG. 8 shows a beam partially focused in x and defocused in y at an image plane located a Z=25 cm in the case of a dipole density of 1.0E9 cm⁻², with a marked circle of radius 100 μm.

FIG. 9 shows transmission through 1 μm of Al as a function of the X-ray energy from Henke's online x-ray transmission calculator.

FIG. 10 illustrations optimization of the deformed potential.

FIG. 11 represents a mass defect difference.

FIG. 12 shows Hg nuclear state transitions.

FIG. 13 shows an apparatus arrangement, according to at least one embodiment, with vibrations off.

FIG. 14 shows the apparatus arrangement of FIG. 13, with vibrations on.

FIG. 15 shows devices and a plot showing resonance according to at least one embodiment.

FIG. 16 shows the apparatus arrangement for upconversion according to at least one embodiment.

FIG. 17 shows devices and a plot showing resonance according to at least one embodiment.

FIG. 18 shows the apparatus arrangement for upconversion according to at least one embodiment, with vibrations on.

FIG. 19 shows a device signal plot.

FIG. 20 shows an apparatus arrangement, according to at least one embodiment, in which little damping effect is characterized.

FIG. 21 shows an apparatus arrangement, according to at least one embodiment, in which medium damping effect is characterized.

FIG. 22 shows an apparatus arrangement, according to at least one embodiment, in which lots of damping effect is characterized.

FIG. 23 shows an apparatus arrangement with little damping, according to at least one embodiment, and a device signal plot.

FIG. 24 shows an apparatus arrangement with medium damping, according to at least one embodiment, and a device signal plot.

FIG. 25 shows an apparatus arrangement with lots of damping, according to at least one embodiment, and a device signal plot.

FIG. 26 shows several device signal plots.

FIG. 27 shows the apparatus arrangement for excitation according to at least one embodiment, with vibrations off.

FIG. 28 shows plots showing resonance according to at least one embodiment.

FIG. 29 shows the apparatus arrangement for excitation according to at least one embodiment, with vibrations on.

FIG. 30 shows plots showing X-ray emissions.

FIG. 31 shows an apparatus arrangement with lots of damping, according to at least one embodiment, and a device signal plot.

FIG. 32 shows several device signal plots.

FIG. 33 shows several device signal plots.

FIG. 34 is a plot of X-123 detector measurements (0-6 KeV).

FIG. 35 is a plot of X-123 detector measurements (6-7 KeV).

FIG. 36 is a plot of X-123 detector measurements (7-8 KeV).

FIG. 37 is a plot of X-123 detector measurements (8-14 KeV).

FIG. 38 is a plot of X-123 detector measurements (14-15 KeV).

FIG. 39 shows plots of X-123 detector measurements (higher plot 6-7 KeV, lower plot 14-15 KeV).

FIG. 40 is a plot of X-123 detector measurements (15-25 KeV).

FIG. 41 shows Rad-film data, log-lin plots (1-2 KeV).

FIG. 42 shows Rad-film data, log-lin plots (2-4 KeV).

FIG. 43 shows Rad-film data, log-lin plots (4-10 KeV)

FIG. 44 shows Rad-film data, log-lin plots (10-20 KeV).

FIG. 45 shows Rad-film data, log-lin plots (10-20 KeV)

FIG. 46 is a plot of Geiger counter data.

FIG. 47 is a plot of average neutron counts/minute.

### DETAILED DESCRIPTIONS

### 1. Introduction

These description detail a model for beam formation due to many emitting dipoles randomly positioned within a circle on a mathematically flat surface. When the emitting dipole density is low, a speckle pattern is produced. Above a critical emitting dipole density beam formation occurs. The average intensity of the speckle and beam is estimated from simple statistical models at low and high dipole density, and combined to develop an empirical intensity estimate over the full range of dipole densities which compares well with numerical simulations. Beam formation occurs above a critical number of emitting dipoles, which allows us to develop an estimate for the minimum number of emitting dipoles present in prior observations. The effect of surface deformations is considered; constant offsets do not impact beam formation, and locally linear offsets direct the beam slightly off of normal. Minor displacements quadratic in the surface coordinates can produce focusing and defocusing effects, leading to a natural explanation for intense spot and line formation observed in experiments.

Collimated X-ray emission in this experiment is a striking anomaly for a variety of reasons. In order to arrange for collimated X-ray emission, either you need an X-ray laser, or else you need coherence among the emitter phases; either option would have deep implications. Karabut was convinced, especially in his later years, that he had made an X-ray laser. In some recent articles Ivlev speculates about the possibility of an X-ray laser mechanism in connection with Karabut's experiment. In years past the author spent a decade modeling and designing X-ray lasers; an experience that led to an understanding of just how difficult it is to create a relevant population inversion and to amplify X-rays. The notion of a population inversion at 1.5 keV involving electronic transitions in a solid state environment is unthinkable due to the very short lifetime. And then even if somehow a population inversion could be generated, one would need enough amplifier length to produce a collimated beam (the solid state medium is very lossy), as well as an amplifier geometry consistent with the observed beam formation. The very broad line shape associated with the collimated emission also argues against an X-ray laser mechanism. All of these headaches combine to rule out an X-ray laser mechanism associated with the solid. The primary headache associated with an X-ray laser in the gas phase is the absence of relevant electronic transitions in hydrogen, deuterium, helium and in neon gas. In this case one could contemplate the possibility of a ubiquitous impurity in the discharge gas; however, this leads to an additional headache of coming up with enough inverted atoms, molecules or ions to provide many gain lengths. If somehow one has any optimism left for the approach, a consideration of the relatively long (millisecond) duration of the collimated X-ray emission following the turning off of the discharge current should provide a cure. If the upper state radiative life time is long then the gain is very low; and if the gain is high then the upper state radiative life time is very short and the power requirement becomes prohibitive.

All of these arguments have led us to consider collimated X-ray emission as a result of a phased array emission effect. In this case serious issues remain; such as how excitation is produced (which in this case is much easier since a population inversion is not required);and how phase coherence might be established. From our perspective, both excitation and phase coherence could be developed via the up-conversion of vibrations to produce nuclear excitationin201 Hg, which is special because it has the lowest energy excited state (at 1565 eV) of any of the stable nuclei. We have reported on our earlier studies of models that describe up-conversion in the lossy spin-boson model, and various extensions and generalizations. In this work we consider models for beam formation of the collimated X-ray emission in Karabut's experiment based on the assumption of phase coherent emitting dipoles randomly positioned on a plane, in connection with the “diffuse” X-ray emission effect observed under “normal” high-current operating conditions. The collimated X-rays in this case were observed to be normal to the cathode in a beam essentially the same size as the cathode; we find that beam formation in the high dipole density of the model (where the emission is produced from localized dipoles)works the same way. When the emitting dipole density is low then no beam forms, but a speckle pattern is produced. It might be proposed that the very intense spots seen in the experiments following the turning off of the discharge are connected with the random constructive interference effects that lead to speckle. However, we find that individual spots associated with the speckle pattern are too small to account for this “sharp” emission effect, and that speckle cannot account for lines or curves. Instead we find that spot formation and line formation follow naturally from models that describe surface deformations that are quadratic or higher-order in the transverse surface coordinates. A weak speckle pattern is generated at low emitting dipole density, and a beam is produced when the emitting dipole density is high. A critical number or density of emitting dipoles can be estimated for the development of a beam. Since beam formation is reported in Karabut's experiment, it is possible to develop a constraint on the number of emitting dipoles consistent with experiment. We have conjectured previously that a small amount of mercury contamination in the chamber might result in some mercury sputtered onto the cathode surface, resulting in a relatively small number of mercury nuclei that emit on a broadened version of the 1565 eV transition in201 Hg. It is possible to develop a lower bound on the number of mercury atoms present near the surface, to see whether it is consistent with the proposed picture.

Key features of the model which allows for collimation of the emitted beam normal to the surface are the phase coherence assumed, as well as the surface itself (which in the model is mathematically flat). There is no reason to think that the cathode surface is flat at the atomic scale, since whatever the surface looked like initially is modified in the ion bombardment, and surface loss through sputtering, which occurs during discharge operation at high current density. Mercury atoms in the discharge gas ionized above the cathode fall would be accelerated toward the cathode surface in this picture with an energy of up to a few keV, which means that they would end up randomly positioned in the outer 5-10 nm of the cathode surface. If so, then one would not expect any alignment in a plane, as assumed in the model, unless there were an ordering of the crystal planes so that some fraction of them were aligned with the cathode surface. The expected randomization of the locations of the mercury atoms inside the cathode surface would make beam formation to be impossible, except from the occasional crystal plane accidentally aligned with the surface.

However, it is well known in the literature that substantial deformation of a metal, as occurs during rolling, can result in a substantial alignment of the local crystal planes with the surface [17-19]. It seems likely that the cathodes used by Karabut were from stock that was rolled, so that one would expect the cathodes themselves to provide a source of crystal planes oriented with the surface. During the discharge operation the cathodes undergo additional surface deformation due to local thermal effects and electrostatic forces, which provides a natural mechanism for intense spot and line formation. In this picture the crystal ordering built in during rolling is largely maintained during the deformations that occuring during discharge operation.

### 2. Basic Model

We note that models for random arrays of emitting dipoles have been studied previously; in the case, of random linear arrays, see [20-23]; a model for a random distribution of antennas in a two dimensional circle has been studied in [24]; and for a random distribution in a triangle in [25]. Statistical models for the analysis of beam formation from random antenna arrays have also been discussed in [26-28].

Following the discussion above, we turn our attention to a simple model for X-ray emission due to a collection of identical emitting dipoles that are randomly distributed in a plane. We can write for the vector potential in the case of oscillating electric dipoles [29] the summation

$$A ( r ) = - i {\sum }_{j} \frac{k {p}_{j}}{\vert r - {r}_{j} \vert} exp \{ ik \vert r - {r}_{j} \vert \} \to - i \frac{k p}{\vert r \vert} {\sum }_{j} exp \{ ik \vert r - {r}_{j} \vert \} , \qquad ( 1 )$$

where we have assumed uniform phase, identical dipoles, and we focus on the field that results far away from the plane. The nuclear transition in ²⁰¹Hg is a magnetic dipole transition, which provides the motivation to consider the analogous approximation for a set of oscillating magnetic dipoles

$$A ( r ) = i {\sum }_{j} \frac{k {\hat{n}}_{j} \times {m}_{j}}{\vert r - {r}_{j} \vert} exp \{ ik \vert r - {r}_{j} \vert \} \to i \frac{k \hat{n} \times m}{\vert r \vert} {\sum }_{j} exp \{ ik \vert r - {r}_{j} \vert \} . \qquad ( 2 )$$

In either case, the resulting intensity is proportional to

$$I ( r ) ∼ {\vert {\sum }_{j} exp \{ ik \vert r - {r}_{j} \vert \} \vert}^{2} = {\sum }_{j} {\sum }_{{j}^{′}} exp \{ ik ( \vert r - {r}_{j} \vert - \vert r - {r}_{{j}^{′}} \vert ) \} . \qquad ( 3 )$$

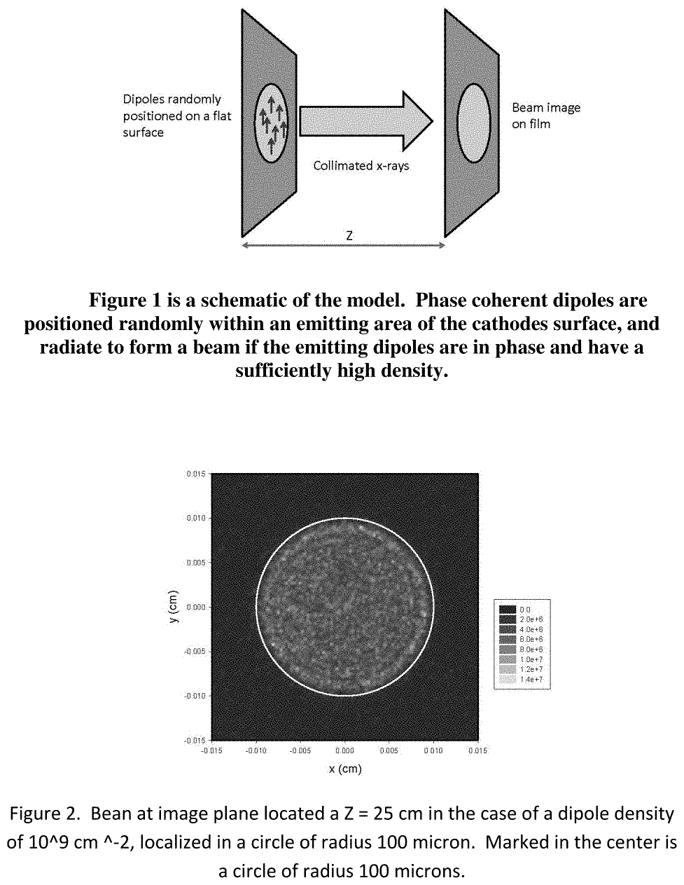

The dipoles are assumed to lie in the emitting plane defined by zⱼ=0, and we are interested in the intensity pattern produced at image plane defined by z=Z (a schematic is shown in FIG. 1). In this case we can write

$$I ( x , y , Z ) ∼ {\sum }_{j} {\sum }_{{j}^{′}} exp \{ ik ( \sqrt{{( x - {x}_{j} )}^{2} + {( y - {y}_{j} )}^{2} + {Z}^{2}} - \sqrt{{( x - {x}_{{j}^{′}} )}^{2} + {( y - {y}_{{j}^{′}} )}^{2} + {Z}^{2}} ) \} . \qquad ( 4 )$$

Simulations based on this model predicts beam formation for small areas when the dipole density is high, and spot formation in the case of larger areas or when the dipole density is low.

Since the locations of the dipoles are probabilistic, it will be of interest to estimate the expectation value of the intensity

$$E [ I ( r ) ] ∼ {\sum }_{j} {\sum }_{{j}^{′}} E [ exp \{ ik ( \vert r - {r}_{j} \vert - \vert r - {r}_{{j}^{′}} \vert ) \} ] . \qquad ( 5 )$$

In what follows we will focus on specific model results for the summation on the right-hand side.

### 3. Beam Formation in the High Density Limit

Beam formation occurs when there are several dipoles that are sufficiently close together so that their contributions can combine coherently. In this regime there is the possibility of making use of a Taylor series expansion according to

$$\begin{matrix}\vert r - {r}_{j} \vert = \sqrt{{( x - {x}_{j} )}^{2} + {( y - {y}_{j} )}^{2} + {Z}^{2}} \\ = Z \sqrt{1 + \frac{{( x - {x}_{j} )}^{2}}{{Z}^{2}} + \frac{{( y - {y}_{j} )}^{2}}{{Z}^{2}}} \\ = Z [ 1 + \frac{{( x - {x}_{j} )}^{2}}{2 {Z}^{2}} + \frac{{( y - {y}_{j} )}^{2}}{2 {Z}^{2}} + … ] .\end{matrix} \qquad ( 6 )$$

In this case we can write for the difference

$$\begin{matrix}\vert r - {r}_{j} \vert - \vert r - {r}_{{j}^{′}} \vert = \frac{{( x - {x}_{j} )}^{2}}{2 Z} + \frac{{( y - {y}_{j} )}^{2}}{2 Z} - \frac{{( x - {x}_{{j}^{′}} )}^{2}}{2 Z} - \frac{{( y - {y}_{{j}^{′}} )}^{2}}{2 Z} + … \\ = \frac{( {x}_{{j}^{′}} - {x}_{j} ) x + ( {y}_{{j}^{′}} - {y}_{j} ) y}{Z} + \frac{{x}_{j}^{2} - {x}_{{j}^{′}}^{2} + {y}_{j}^{2} - {y}_{{j}^{′}}^{2}}{2 Z} + …\end{matrix} \qquad ( 7 )$$

If we assume that beam formation is dominated by contributions from the lowest order terms in the Taylor series expansion, then we can write

$$I ( x , y , Z ) ∼ {\sum }_{j} {\sum }_{{j}^{′}} exp \{ ik ( \frac{( {x}_{{j}^{′}} - {x}_{j} ) x + ( {y}_{{j}^{′}} - {y}_{j} ) y}{Z} + \frac{{x}_{j}^{2} - {x}_{{j}^{′}}^{2} + {y}_{j}^{2} - {y}_{{j}^{′}}^{2}}{2 Z} ) \} . \qquad ( 8 )$$

The locations of the emitting dipoles are random variables, so that the intensity will be random as well. It will be of interest to estimate the expectation value of the intensity which we can write as

$$E [ I ( x , y , Z ) ] ∼ {\sum }_{j} {\sum }_{{j}^{′}} E [ exp \{ ik ( \frac{( {x}_{{j}^{′}} - {x}_{j} ) x + ( {y}_{{j}^{′}} - {y}_{j} ) y}{Z} + \frac{{x}_{j}^{2} - {x}_{{j}^{′}}^{2} + {y}_{j}^{2} - {y}_{{j}^{′}}^{2}}{2 Z} ) \} ] . \qquad ( 9 )$$

If we assume that the various xⱼ and yⱼ values are independent, then this becomes

$$E [ I ( x , y , Z ) ] ∼ {\sum }_{j} {\sum }_{{j}^{′}} E [ exp \{ ik ( \frac{- 2 {x}_{j} x + {x}_{j}^{2}}{2 Z} ) \} ] E [ exp \{ - ik ( \frac{2 {x}_{{j}^{′}} x + {x}_{{j}^{′}}^{2}}{2 Z} ) \} ] , \\ E [ exp \{ ik ( \frac{- 2 {y}_{j} y + {y}_{j}^{2}}{2 Z} ) \} ] E [ exp \{ - ik ( \frac{2 {y}_{{j}^{′}} y + {y}_{{j}^{′}}^{2}}{2 Z} ) \} ] = {N}^{2} {\vert E [ exp \{ ik ( \frac{- 2 {x}_{j} x + {x}_{j}^{2}}{2 Z} ) \} ] E [ exp \{ ik ( \frac{- 2 {y}_{j} y + {y}_{j}^{2}}{2 Z} ) \} ] \vert}^{2} . \qquad ( 10 )$$

For simplicity, let us assume uniform probability distributions for a square emitting region defined' by

$${f}_{X} ( {x}_{j} ) = \frac{1}{L} ( - L / 2 < x < L / 2 ) , \\ {f}_{Y} ( {y}_{j} ) = \frac{1}{L} ( - L / 2 < x < L / 2 ) . \qquad ( 11 )$$

Also for simplicity let us focus on the origin at the image, so that

$$E [ I ( 0 , 0 , Z ) ] ∼ {N}^{2} {\vert E [ exp \{ ik ( \frac{{x}_{j}^{2}}{2 Z} ) \} ] E [ exp \{ ik ( \frac{{y}_{j}^{2}}{2 Z} ) \} ] \vert}^{2} . \qquad ( 12 )$$

We can approximate

$$\begin{matrix}E [ exp \{ ik ( \frac{{x}_{j}^{2}}{2 Z} ) \} ] = {\int }_{- L / 2}^{L / 2} {f}_{X} ( {x}^{′} ) exp \{ ik ( \frac{{x}_{j}^{2}}{2 Z} ) \} {dx}^{′} \\ \to \frac{1}{L} {\int }_{- ∞}^{∞} exp \{ ik ( \frac{{x}_{j}^{2}}{2 Z} ) \} {dx}^{′} \\ = \frac{1}{L} \sqrt{\frac{i 2 π Z}{k}} \\ = \frac{1}{L} \sqrt{i λ Z} .\end{matrix} \qquad ( 13 )$$

We end ⁻up with

$$E [ I ( 0 , 0 , Z ) ] ∼ \frac{{( λ Z )}^{2}}{{L}^{4}} {N}^{2} . \qquad ( 14 )$$

We have verified that the numerical are consistent with this estimate in the limit of high dipole density for a square emitting region. Adapting this formula to enussion from a circular area by simply modifying the area appears to work well in comparison with numerical results,

### 4. Average Intensity in the Low Density Limit

We recall that the expectation value of the intensity is proportional to

$$E [ I ( r ) ] ∼ {\sum }_{j} {\sum }_{{j}^{′}} E [ exp \{ ik ( \vert r - {r}_{j} \vert - \vert r - {r}_{{j}^{′}} \vert ) \} ] . \qquad ( 15 )$$

In the high density limit we took advantage of a Taylor series approximation, as well the separability of the sums in j and in j′, to develop an estimate for the expectation value. In the low density limit it is possible to develop an estimate, for the expectation value of the intensity by neglecting contributions from dipoles at different locations; at low density there are not nearby emitting dipoles for local phase coherence to contribute significantly. In this case we can write

$$E [ I ( r ) ] ∼ {\sum }_{j} E [ exp \{ ik ( \vert r - {r}_{j} \vert - \vert r - {r}_{j} \vert ) \} ] + {\sum }_{j} {\sum }_{{j}^{′} \neq j} E [ exp \{ ik ( \vert r - {r}_{j} \vert - \vert r - {r}_{{j}^{′}} \vert ) \} ] = N + {\sum }_{j} {\sum }_{{j}^{′} \neq j} E [ exp \{ ik ( \vert r - {r}_{j} \vert - \vert r - {r}_{{j}^{′}} \vert ) \} ] \to N . \qquad ( 16 )$$

When the dipole density is low then the expectation value of the complex terms can be thought of as involving random phases so that

$$E [ exp \{ ik ( \vert r - {r}_{j} \vert - \vert r - {r}_{{j}^{′}} \vert ) \} ] \to E [ {e}^{i θ} ] = \frac{1}{2 π} {\int }_{0}^{2 π} {e}^{i θ} d θ = 0.$$

In this limit there is no beam formation; instead there is a speckle pattern with average intensity proportional to N, in the vicinity of where a beam might have formed if N were higher, and also away from where the beam might have formed.

It is possible to develop an empirical approximation that includes both the contribution from the low density limit and from the high density limit according to

$$E [ I ( r ) ] ∼ {\vert {\sum }_{j} exp \{ ik \vert r - {r}_{j} \vert \} \vert}^{2} = \{ \begin{matrix}N + {( \frac{λ Z}{{L}^{2}} )}^{2} {N}^{2} , & within beam pattern , \\ N , & outside of beam .\end{matrix} \qquad ( 17 )$$

This result is closely related to the exact formal result for the expectation value in [27,31].

### 5. Numerical Results

We have carried out simulations with randomly located dipoles in a square corresponding to the models described above, and have found good agreement with the simple probabilistic models outlined above. The exposed surface of the cathodes in the Karabut experiment are circular, which motivates us to consider the generalization

$$E [ I ( r ) ] ∼ E [ {\vert {\sum }_{j} exp \{ ik \vert r - {r}_{j} \vert \} \vert}^{2} ] = \{ \begin{matrix}N + {( \frac{λ Z}{π {R}^{2}} )}^{2} {N}^{2} , & within beam pattern , \\ N , & outside of beam\end{matrix} \qquad ( 18 )$$

appropriate to emitting dipoles within a circular region of radius R.

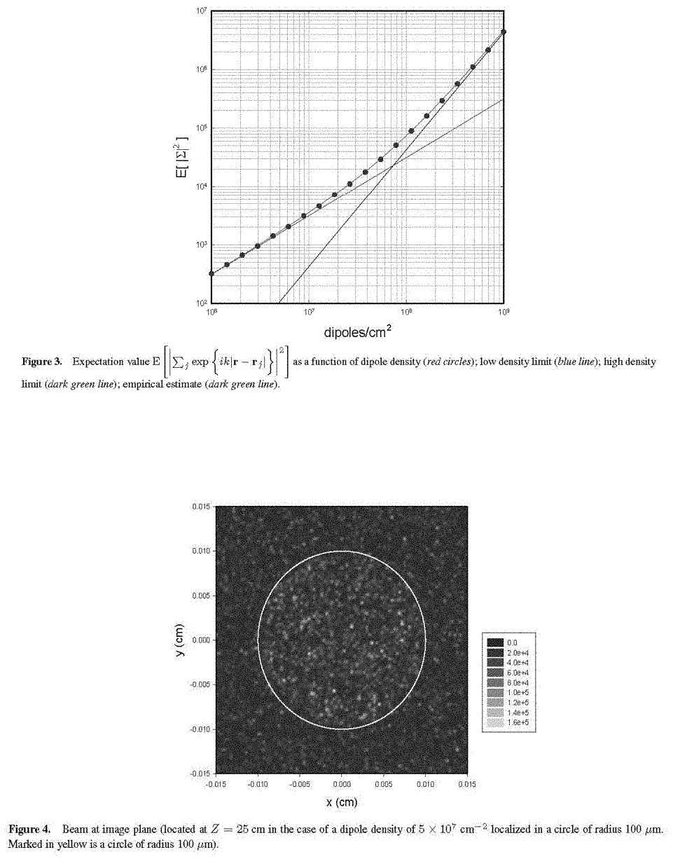

An example of beam formation is illustrated in FIG. 2, where we see that dipoles randomly localized on a plane within a circle of radius 100 μm results in a circular beam with a radius 100 μm. Diffraction rings are apparent in the image which are a result of the discontinuity in the dipole density near the edge of the circular emitting area. One also sees a speckle pattern which results from the limited number of dipoles present in the calculation,

In FIG. 3 is shown the average intensity (from many simulations) in the case of a 100 μm radius circle containing random emitting dipoles and a 100 μm radius circle on the image plane displaced 25 cm in z. One can see that at low dipole density the average intensity is that of a spot pattern, and at high intensity the average intensity matches the analytic estimate. The empirical formula of Eq. (18) is seen to be a good match over the whole range of dipole densities.

### 6. Beam Formation in the Karabut Experiment

Although we have no published photographic record of beam formation in Karabut's experiment, there are two photographs that show the damage done to a Be window and a plastic window in [30]. It might have been possible to discern the amount of speckle present from an X-ray photographic image of the beam, which based on the analysis above would have provided us with information about how many emitting dipoles are present. In some of the photographic spectra taken in the bent mica crystal spectrometer configuration of Ref. [8] there is obvious speckle present,

which tells us that the quadratic beam contribution to the intensity is not so many orders of magnitude greater than the linear speckle contribution.

From the empirical model described above we can define a critical number of dipoles Nₒ at which the linear and quadratic contributions match

$${N}_{0} = {( \frac{λ Z}{π {R}^{2}} )}^{2} {N}_{0}^{2} . \qquad ( 19 )$$

We can evaluate

$${N}_{0} = {( \frac{π {R}^{2}}{λ Z} )}^{2} . \qquad ( 20 )$$

If we assume that phase coherence among the, emitting dipoles is established over the entire surface of the cathode, then we can develop a numerical estimate for the critical number of dipoles. For this estimate we take

R=0.5 cm, λ=8 nm, Z=25 cm. (21)

The corresponding critical number in this case is

N₀=1.5×10¹¹. (22)

In this, picture we would good expect beam, formation when the number of dipoles is larger than N₀ by an order of magnitude or more.

Another possibility is that phase coherence is established over only a part of the cathode surface, in which case the critical number of dipoles would be smaller by the square of the ratio of the coherence area to the cathode area.

### 7. Spot Formation

When the dipole density is low we see speckle formation in the image plane, which is a consequence of fluctuations in the intensity. We are interested in the development of a model that we can use to estimate the intensity of a spot given the number of emitting dipoles in a given area.

We recall that the intensity is determined from the random locations of the dipoles according to

$$I ( r ) ∼ {\vert {\sum }_{j} exp \{ ik \vert r - {r}_{j} \vert \} \vert}^{2} . \qquad ( 23 )$$

To form a spot we need for the phases associated with the different dipoles to be nearly the same. In this model we are specifically not interested the phase coherence associated with, beam,formation, in which the contribution from many dipoles near a point add coherently. Instead we are interested in spot formation where the contribution from dipoles that are well separated combine randomly.

Since the contribution from each dipole is assumed to be equal in this model, the only difference in the contribution comes from the phase factor. If the dipole positions are random, then we might presume that the associated phases are random as well. Consequently, we might consider the simpler model defined by

$$θ = {\vert {\sum }_{j = 1}^{N} exp \{ i {φ}_{j} \} \vert}^{2} = {\sum }_{j = 1}^{N} {\sum }_{k = 1}^{N} exp \{ i ( {φ}_{j} - {φ}_{k} ) \} . \qquad ( 24 )$$

From numerical simulations, the associated probability distribution is exponential in 0 according to

$${f}_{Θ} ( θ ) \to \frac{1}{N} exp \{ - \frac{θ}{N} \} . \qquad ( 25 )$$

This result is consistent with a random walk model in two dimensions, and is well known in the literature in the context of speckle [32]. In the event that fewer than the critical number of dipoles emit in this model, then there is little or no beam apparent, but instead individual randomly positioned spots associated with speckle.

According to this model the average intensity will be proportional to N

E[I]˜E[θ]=N (26)

with spots at higher intensity being rarer exponentially in the intensity. This result is consistent with the low dipole density model discussed briefly above, where

$$E [ I ( r ) ] ∼ E [ {\vert {\sum }_{j} exp \{ ik \vert r - {r}_{j} \vert \} \vert}^{2} ] = N . \qquad ( 27 )$$

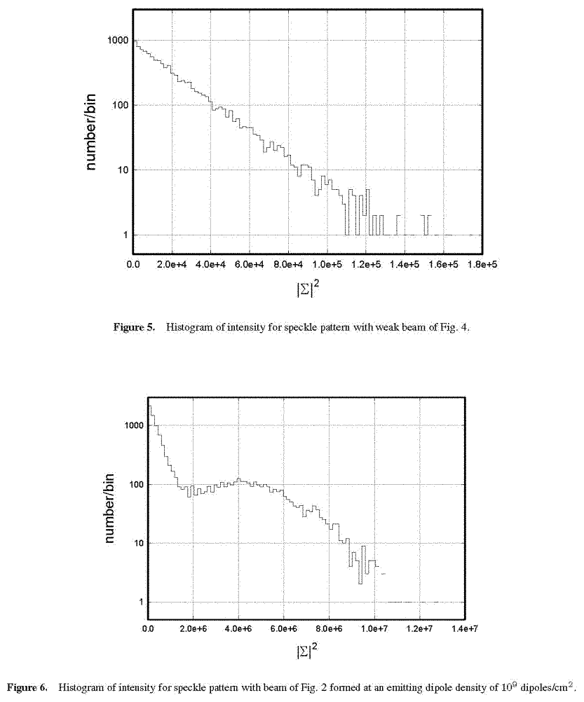

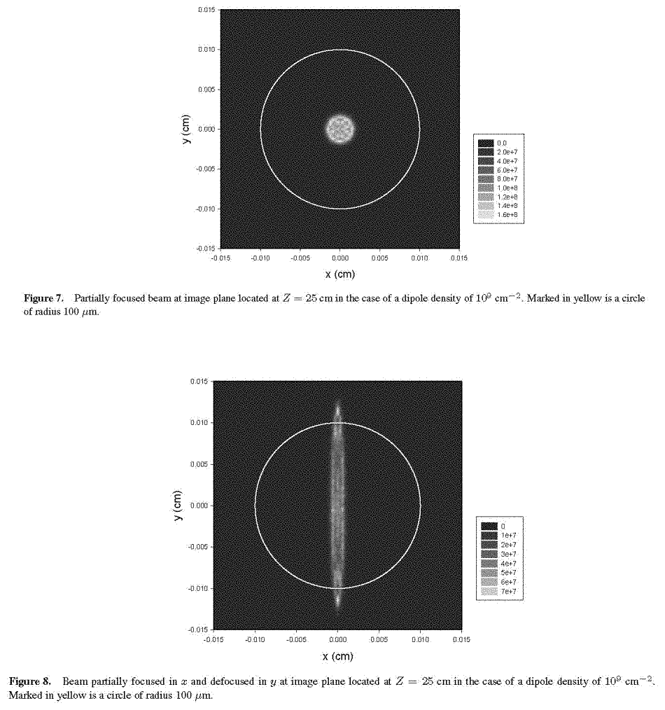

In FIG. 4 we show a calculated image of the weak beam and spots under conditions where the density of dipoles is lower, so that the total number of emitting dipoles is a bit less than the critical number. In this case the dipole density is 5×10⁷ cm ⁻², and the critical density needed for beam formation is about 7.4×10⁷ cm⁻². A histogram of intensities for the speckle pattern and weak beam inside of the indicated circle is shown in FIG. 5, and is seen to be close to exponential consistent with the discussion above, and in this case the number of match dipoles in the circle is a reasonable match to the exponential fall off.

Karabut reported that the “diffuse” spectra that he observed appears when the discharge is running, and that the very intense “sharp” emission could be seen when the discharge was turned off suddenly [8]. In this case there is a large current spike (short in time) which accompanies the turning off of the current. Of interest is how this “sharp” emission might be interpreted. We previously proposed that this effect could be a result of Dicke superradiance from emitting dipoles in a localized region, where the emitting region was thought to be on the order of a square millimeter [33]. In the following section surface deformations will be considered, which will provide a superior interpretation.

We might have conjectured that the very intense spots might be a speckle effect under conditions where the individual dipole emission is stronger than in the case of beam formation. One argument against such a proposal is that individual speckles in this calculation are quite small, with a peak intensity only over a few microns by a few microns. The intense features in Karabut's data are much larger.

It is of interest to examine the intensity distribution in the case of beam formation. In FIG. 6 we show a histogram of the intensities when the emitting dipole density is 10⁹ cm⁻². This intensity distribution corresponds to the beam illustrated in FIG. 2, which shows some diffraction rings inside near the boundary of the circle. The brightest speckles are seen to be associated with the outermost diffraction ring which is on average brightest. Once again the individual speckles in this calculation are very small, and we would not expect them to account for the intense spots seen, in Karabut's experiment.

### 8. Surface Deformation Effects

After a number of runs in the glow discharge, the cathode has undergone plastic deformations (as was clear in experiments done at MIT with a copy of Karabut's system in the 1990s prior to the discovery of the collimated X-ray emission effect). Consequently, we would not expect there to be a mathematically flat surface present, even if the cathode somehow started out mathematically flat. There are also transient effects associated with compressional, transverse, and drum head mode excitation. We would expect the largest dynamic effects to be due to excitation of the drum head modes.

It is possible to include these effects in, our description by working with a displacement field u (x, y, t) which keeps track of the amount of displacement in the different directions. The intensity pattern including surface displacement can be written as

$$I ( r , t ) ∼ {\vert {\sum }_{j} exp \{ ik \vert r - {r}_{j} - u ( {r}_{j} , t ) \vert \} \vert}^{2} . \qquad ( 28 )$$

The idea here is that the dipole positions rⱼ are specified in the case of a mathematically flat surface. When the'surface is displaced, the (slowly varying) displacement is added systematically to the initial positions of the dipoles in the contribution to the phase factors.

Since we expect the largest effect to come from drum head mode displacements and plastic deformations, we can restrict the surface displacement to be normal to the surface

u(r,t)=î_{z}u(x,y,t). (29)

It will be informative to consider the impact of low-order variations in the displacement; consequently, we work with a Taylor series expansion around the origin given by

$$u ( x , y , t ) = u ( 0 , 0 , t ) + x \frac{\partial u}{\partial x} + y \frac{\partial u}{\partial y} + \frac{1}{2} {x}^{2} \frac{{\partial }^{2} u}{\partial {x}^{2}} + xy \frac{{\partial }^{2} u}{\partial x \partial y} + \frac{1}{2} {y}^{2} \frac{{\partial }^{2} u}{\partial {y}^{2}} + … , \qquad ( 30 )$$

where the various derivatives are evaluated at x=0 and y=0, and may be oscillatory in time.

### 8.1. Uniform Displacement

We consider first the impact of a uniform displacement

u(x,y,t)=u(0,0,t)=u₀(t) (31)

In this case we can write for the intensity

$$\begin{matrix}I ( r , t ) ∼ {\vert {\sum }_{j} exp \{ ik \vert r - {r}_{j} - {\hat{i}}_{z} {u}_{0} ( t ) \vert \} \vert}^{2} \\ = {\vert {\sum }_{j} exp \{ ik \sqrt{{( x - {x}_{j} )}^{2} + {( y - {y}_{j} )}^{2} + {( Z - {u}_{0} ( t ) )}^{2}} \} \vert}^{2} .\end{matrix} \qquad ( 32 )$$

Since we expect the largest displacement to be very small compared to the distance between the cathode and image plane

|u₀(t)|«Z, (33)

we do not anticipate observable effects from uniform surface displacements.

### 8.2, Linear Displacements

Next we consider linear displacements of the form

u(x,y,t)=a(t)x+b(t)y. (34)

In this case we can write

$$I ( r , t ) ∼ {\vert {\sum }_{j} exp \{ ik \sqrt{{( x - {x}_{j} )}^{2} + {( y - {y}_{j} )}^{2} + {[ Z - a ( t ) {x}_{j} - b ( t ) {y}_{j} ]}^{2}} \} \vert}^{2} . \qquad ( 35 )$$

We would expect the beam to be offset (in the high dipole density limit) depending on the surface gradient. We can include this effect by writing

$$( 36 ) \\ I ( {r}^{′} ( t ) , t ) = I ( r + {\hat{i}}_{x} δ x ( t ) + {i}_{y} δ y ( t ) , t ) ∼ \vert {\sum }_{j} exp {\{ ik \sqrt{{[ x + δ x ( t ) - {x}_{j} ]}^{2} + {[ y + δ y ( t ) - {y}_{j} ]}^{2} + {[ Z - a ( t ) {x}_{j} - b ( t ) {y}_{j} ]}^{2}} \} \vert}^{2} .$$

We can eliminate some of the low' order terms in the phase by choosing

δx(t)=−Za(t), δy(t)=−Za(t). (37)

If we focus on the beam originally at the origin of the image plane then we can write

$$( 38 )$$

$$I ( {\hat{i}}_{x} δ x ( t ) + {i}_{y} δ y ( t ) , t ) ∼ {\vert {\sum }_{j} exp \{ ik \sqrt{{[ δ x ( t ) - {x}_{j} ]}^{2} + {[ δ y ( t ) - {y}_{j} ]}^{2} + {[ Z - a ( t ) {x}_{j} - b ( t ) {y}_{j} ]}^{2}} \} \vert}^{2} = {\vert {\sum }_{j} exp \{ ik \sqrt{{x}_{j}^{2} + {y}_{y}^{2} + {Z}^{2} + δ {x ( t )}^{2} + δ {y ( t )}^{2} + {[ a ( t ) {x}_{j} + b ( t ) {y}_{j} ]}^{2}} \} \vert}^{2} .$$

If the displacements are small, then the higher-order terms can be neglected, and we have the approximate result

$$I ( {\hat{i}}_{x} δ x ( t ) + {i}_{y} δ y ( t ) , t ) ∼ {\vert {\sum }_{j} exp \{ ik \sqrt{{x}_{j}^{2} + {y}_{j}^{2} + {Z}^{2}} \} \vert}^{2} . \qquad ( 39 )$$

### 8.3. Surface Curvature

If the surface is curved, there is the possibility of increasing or reducing the beam intensity, since it may be that phase coherence can be maintained for more emitting dipoles. In general we can describe a curved surface through displacements of the form

u(x,y)=c(t)x²+d(t)y²+f(t)xy. (40)

In this case we can write

$$( 41 )$$

$$I ( r , t ) ∼ {\vert {\sum }_{j} exp \{ ik \vert r - {r}_{j} - {\hat{i}}_{z} [ c ( t ) {x}_{j}^{2} + d ( t ) {y}_{j}^{2} + f ( t ) {x}_{j} {y}_{j} ] \vert \} \vert}^{2} = {\vert {\sum }_{j} exp \{ ik \sqrt{{( x - {x}_{j} )}^{2} + {( y - {y}_{j} )}^{2} + {[ Z - c ( t ) {x}_{j}^{2} - d ( t ) {y}_{j}^{2} - f ( t ) {x}_{j} {y}_{j} ]}^{2}} \} \vert}^{2} .$$

The intensity at the origin reduces to

$$I ( 0 , 0 , Z , t ) ∼ {\vert {\sum }_{j} exp \{ ik \sqrt{{x}_{j}^{2} + {y}_{j}^{2} + {[ Z - c ( t ) {x}_{j}^{2} - d ( t ) {y}_{j}^{2} - f ( t ) {x}_{j} {y}_{j} ]}^{2}} \} \vert}^{2} . \qquad ( 42 )$$

Note that it is possible to arrange for cancellation if

2Zc(t)−1, 2Zd(t)−1, f(t)−0. (43)

In this case we can write

$$( 44 )$$

$$I ( 0 , 0 , Z , t ) ∼ {\vert {\sum }_{j} exp \{ ik \sqrt{{Z}^{2} + \frac{{( {x}_{j}^{2} + {y}_{j}^{2} )}^{2}}{4 {Z}^{2}}} \} \vert}^{2} = {\sum }_{j} {\sum }_{{j}^{′}} exp \{ ik ( \sqrt{{Z}^{2} + \frac{{( {x}_{j}^{2} + {y}_{j}^{2} )}^{2}}{4 {Z}^{2}}} - \sqrt{{Z}^{2} + \frac{{( {x}_{{j}^{′}}^{2} + {y}_{{j}^{′}}^{2} )}^{2}}{4 {Z}^{2}}} ) \} .$$

We can make use of a Taylor series expansion in this ease to write

$$\sqrt{{Z}^{2} + \frac{{ρ}_{j}^{4}}{4 {Z}^{2}}} - \sqrt{{Z}^{2} + \frac{{ρ}_{{j}^{′}}^{4}}{4 {Z}^{2}}} = \frac{{ρ}_{j}^{4} - {ρ}_{{j}^{′}}^{4}}{8 {Z}^{3}} + … \qquad ( 45 )$$

The intensity in this limit is approximately

$$I ( 0 , 0 , Z , t ) ∼ {\sum }_{j} {\sum }_{{j}^{′}} exp \{ ik ( \frac{{( {x}_{j}^{2} + {y}_{j}^{2} )}^{2} - {( {x}_{{j}^{′}}^{2} + {y}_{{j}^{′}}^{2} )}^{2}}{8 {Z}^{3}} ) \} . \qquad ( 46 )$$

It is probably simplest to evaluate the expectation value assuming N emitting dipoles in a circular area with radius ρ₀, around the origin, in which case the expectation value of the intensity is

$$E [ I ( 0 , 0 , Z , t ) ] ∼ E [ {\sum }_{j} {\sum }_{{j}^{′}} exp \{ ik ( \frac{{( {x}_{j}^{2} + {y}_{j}^{2} )}^{2} - {( {x}_{{j}^{′}}^{2} + {y}_{{j}^{′}}^{2} )}^{2}}{8 {Z}^{3}} ) \} ] = {N}^{2} {\vert E [ exp \{ ik ( \frac{{ρ}_{j}^{4}}{8 {Z}^{3}} ) \} ] \vert}^{2} . \qquad ( 47 )$$

To evaluate the expectation value we make use of a radial probability distribution given by

$$f ( ρ ) = \{ \begin{matrix}\frac{2 ρ}{{ρ}_{0}^{2}} , & 0 \leq ρ \leq {ρ}_{0} , \\ 0 , & otherwise .\end{matrix} \qquad ( 48 )$$

We can compute

$$E [ exp \{ ik ( \frac{{ρ}_{j}^{4}}{8 {Z}^{3}} ) \} ] = \frac{2}{{ρ}_{0}^{2}} {\int }_{0}^{{ρ}_{0}} ρ exp \{ ik ( \frac{{ρ}^{4}}{8 {Z}^{3}} ) \} d ρ . \qquad ( 49 )$$

If the circle is sufficiently large, so that

$$\frac{k {ρ}_{0}^{4}}{8 {Z}^{3}} = \frac{π {ρ}_{0}^{4}}{4 λ {Z}^{3}} ≫ 1 \qquad ( 50 )$$

(the characteristic value of ρ₀ for the numbers under consideration is about 2.5 mm) then we obtain

$$E [ exp \{ ik ( \frac{{ρ}_{j}^{4}}{8 {Z}^{3}} ) \} ] \to \frac{1}{\sqrt{- i}} \sqrt{\frac{2 π {Z}^{3}}{k {ρ}_{0}^{4}}} . \qquad ( 51 )$$

In the end we can write

$$E [ {\sum }_{j} {\sum }_{{j}^{′}} exp \{ ik ( \frac{{( {x}_{j}^{2} + {y}_{j}^{2} )}^{2} - {( {x}_{{j}^{′}}^{2} + {y}_{{j}^{′}}^{2} )}^{2}}{8 {Z}^{3}} ) \} ] = ( \frac{2 π {Z}^{3}}{k {ρ}_{0}^{4}} ) {N}^{2} = ( \frac{λ {Z}^{3}}{{ρ}_{0}^{4}} ) {N}^{2} . \qquad ( 52 )$$

This is a much greater intensity that we obtained with earlier models. Collimated X-ray emission under conditions where the surface is distorted in this way can result in a very intense beam with a corresponding small spot size at the image plane.

We note that surface displacement in this case is a focusing effect, with no enhancement in the, area integral of the intensity at the image plane. An example of a focused beam with parameters

$$c ( t ) = 0.80 \frac{1}{2 Z} , d ( t ) = 0.80 \frac{1}{2 Z} , f ( t ) = 0 \qquad ( 53 )$$

is illustrated in FIG. 7. A beam in the shape of a line longer than the size of the circle containing the emitting dipoles is shown in FIG. 8. In this case the distorted surface parameters are

$$c ( t ) = - 0.30 \frac{1}{2 Z} , d ( t ) = 0.90 \frac{1}{2 Z} , f ( t ) = 0. \qquad ( 54 )$$

### 9. Discussion and Conclusions

Collimated X-ray emission in the Karabut experiment is an anomaly that cannot be Understood based on currently accepted solid state and nuclear physics, which provides motivation for seeking an understanding of the effect. There are two possible origins of a collimation effect: either an X-ray laser has been created; or else beam formation is due to phased array emission. We have argued many times against the proposal that an X-ray laser has been created, in part due to the absence of any compelling mechanism to produce a population inversion, in part due to the associated high power density requirement, and in part due to the mismatch between the geometry needed for beam formation and the geometry of the experiment.

Instead we have conjectured that the collimation is a consequence of phased array emission, a proposal which on the one hand is free of the strong objections against an X-ray laser mechanism, but which on the other hand brings new issues to resolve. The two most significant mechanistic issues are how excitation in the keV range can be produced, and how phase coherence might be established. These problems are very serious; however, in our view there are plausible mechanisms for both of these issues.

Independent of Karabut's experiment we have for many years been interested in mechanisms that might down-convert a large nuclear quantum in the Fleischmann-Pons experiment, to account for excess heat as due to nuclear reactions without commensurate energetic nuclear radiation. The big headache in understanding the mechanism through which excess heat is produced is that in a successful experiment one has the possibility of measuring thermal energy and ⁴He in the gas phase, neither of which at this point shed much light on whatever physical mechanism is involved.

If the large nuclear quantum is being down-converted, then we would want to study the down-conversion mechanism in a different kind of experiment more easily diagnosed and interpreted. Because of the intimate theoretical connection between up-conversion and down-conversion, we have the possibility of understanding how down-conversion works by studying up-conversion. Initially we contemplated a theory-based experiment in which THz vibrations would be up-converted to produce excitation at 1565 eV in ²⁰¹ Hg nuclei, which has the lowest energy excited state of all the stable nuclei, and which would decay primarily by internal conversion but also in part via X-ray emission. In this proposed theory-based experiment we recognized that the up-conversion of vibrational energy would result in phase coherence, with the possibility of phased array beam formation. The claim of collimated X-ray emission near 1.5 keV in the Karabut experiment drew our attention since it seemed that the up-conversion experiment that we were interested might have already been implemented. From this perspective collimation in the Karabut experiment could be interpreted as an experimental confirmation of the up-conversion mechanism, primarily since there seems to be no other plausible interpretation. Collimated X-ray emission claimed in some eases near 1.5 keV in the water jet experiments of Kornilova, Vysotskii and coworkers [34-37] seems to us to be closely related, and to provide another experiment where up-conversion is observed (a point of view we note that is at odds with the theoretical explanation put forth by Vysotskii in these references).

One motivation for the modeling described in this paper was to see whether we might develop constraints on the number of emitting dipoles involved, which according to our picture would shed light on the number of mercury atoms present on the surface. We had thought initially that low levels of mercury as an impurity in the cathodes or in the gas might be responsible for the collimated emission; however, the spectra published by Karabut shows no indication of edge absorption which favors implantation from mercury contamination in the discharge gas. For example, the K-edge absorption in aluminum starts at 1562 eV, which should be readily apparent if the emission originates in the bulk. The transmission for a 1 μm Al layer is close to 90% below the K-edge, and near 30% above the K-edge (see FIG. 9); this difference would be readily apparent in the spectra if the emission was due to bulk radiators. The absence of an observable K-edge absorption feature in the spectrum suggests that the emission is localized to within 0.1 μm or less from the surface, which is consistent with implantation from the mercury as an impurity in the discharge gas. Beam formation requires a dipole density above a threshold value, and we have estimated the threshold to correspond to about 1.5×10¹¹ emitting dipoles in the Karabut experiment. Probably the total number of dipoles is on the order of 1.5×10¹² or higher, to be consistent with unambiguous beam formation. Since the natural abundance of ²⁰¹Hg is 13.18%, this puts the total number of mercury atoms at or above 10¹³.

For beam formation we made use of a model based on emitting dipoles randomly positioned on a mathematical plane within a circle, to match the cathode geometry in Karabut's experiment. Beam formation in this case requires both uniform phase, and for there to be a mathematical plane to restrict random variations in position normal to the surface. In previous work presented at ICCF17 we assumed that the dipoles were randomly spaced in a volume near the surface, which could produce speckles, but we did not appreciate at the time that this model does not produce a beam of about the same size as the cathode. The orientation of the crystal planes aligned with the surface produced by the rolling process used in the fabrication of the foils from which the cathodes are taken is critical for beam formation, based on the model studied in this paper.

We have speculated previously about the origin of the very intense spots and lines that appear on the film (and which produces film damage), including proposals that small fraction of the surface produces a collimated beam to form a spot, and that aline might be produced by a steering effect. Here we have shown that surface deformation can produce a focusing of the beam, both in one dimension to produce a line, and in two dimensions to produce a spot. This new picture provides in our view a much stronger argument than the earlier speculation.

We have previously speculated at ICCF17 that the bursts in emission following the turning off of the discharge was due to nonlinear Rabi oscillations in the donor and receiver model, a proposal strongly criticized by Vysotskii [38] on the grounds that the strong coupling needed to produce such rapid nonlinear Rabi oscillations was unlikely. In retrospect Vysotskii's argument seems right, and we have subsequently been thinking about new models for the up-conversion which will be discussed elsewhere. However, in these models the burst effect comes about from the basic time dependence of the phononnuclear coupling matrix element, which in this case involves two photon exchange since the transition is M1 and the phonon-nuclear interaction is E1, to produce a cos⁴ ω₀t time-dependence which is sharpened by a nonlinearity associated with local up-conversion effects. In this picture the excitation of the ²⁰¹Hg transition is from excitation transfer from much more strongly coupled transitions in the cathode holder and steel target chamber, and drum head mode excitation of the cathode mediates this excitation transfer.
Many anomalies reported in Condensed Matter Nuclear Science
We heave Pursued a model based on Phonon-nuclear coupling . . .
. . . and up-conversion/down-conversion
Capable of describing excess heat and He-4, tritium, low-energy nuclear radiation, transmutation, and collimated x-ray and gamma emission
Basic approach is consistent with modern physical theory
Current effort focusing on developing specific calculations to compare with experiment
Was not obvious how to couple between internal nuclear degrees of freedom and the lattice
Recently found a relativistic interaction which couples lattice vibrations with internal nuclear states
Origin is that the internal strong force interaction depends on nucleus velocity
Dominant part of interaction Hamiltonian for 2-body interaction is

$$\begin{matrix} {\hat{H}}_{int} = \frac{1}{2 Mc} {\sum }_{j < k} [ ( {β}_{j} {α}_{j} + {β}_{k} {α}_{k} ) \cdot \hat{P} , \hat{V} \text{?} ] & ( 55 ) \\ \text{?} \text{indicates text missing or illegible when filed} & \end{matrix}$$

P L Hagelstein, “Quantum Composites: A review, and new results for models for Condensed Matter Nuclear Science”, JCMNS 20 (2016) 139-225

### Where Ta-181 Comes in

Interaction Hamiltonian has E1 multipolarity (weaker at M2, E3, M4 . . . )

Seek lowest energy E1 nuclear transition.

TABLE 1
Low-energy nuclear transitions from the ground
state of stable nuclei, from the BNL online NUDAT2 table.

| | Excited state | | | |
|---|---|---|---|---|
| Nucleus | energy (keV) | Half-life | | Multipolarity |
| ²⁰¹Hg | 1.5648 | 81 | ns | M1 + E2 |
| ¹⁸¹Ta | 6.240 | 6.05 | μs | E1 |
| ¹⁶⁹Tm | 8.41017 | 4.09 | ns | M1 + E2 |
| ⁸³Kr | 9.4051 | 154.4 | ns | M1 + E2 |
| ¹⁸⁷Os | 9.75 | 2.38 | ns | M1(+E2) |
| ⁷³Ge | 13.2845 | 2.92 | μs | E2 |
| ⁵⁷Fe | 14.4129 | 98.3 | ns | M1 + E2 |

From P. L. Hagelstein, “Bird's eye view of phonon models for excess heat in the Fleischmann-Pons experiment,” JCMNS 6 (2012) 169-180

### Low Lying States of Ta-181

TABLE II

| energy | | | | |
|---|---|---|---|---|
| (keV) | J* | [N [symbol] Λ] | orbital | rotational state |
| 0 | 7/2⁺ | [404] | 1 [symbol] | [614] J=7/2 |
| 6.237 | 9/2⁻ | [314] | 1b [symbol] deformed | [314] J=9/2 |
| 136.262 | 9/2⁺ | | | [ [symbol] ] J=9/2 |
| 136.554 | 11/2⁻ | | | [314] J=11/2 |
| 301.662 | 11/2⁺ | | | [404] J=11/2 |
| 337.84 | 13/2⁻ | | | [314] J=31/2 |
| 482.108 | 5/2⁺ | [402] | 2d [symbol] | [402] J=5/2 |
| 496.164 | 13/2⁺ | | | [404] J=13/2 |
| 512.51 | 15/2⁻ | | | [314] J=15/2 |
| 590.06 | 7/2⁺ | | | [402] J=7/2 |
| 616.19 | 1/2⁺ | [411] | 3 [symbol] | [411] J=1/2 |
| 618.99 | 5/2⁺ | | | [411] J=3/2 |
| 716.830 | 15/2⁺ | | | [404] J=16/2 |
| 727.31 | 9/2⁺ | | | [402] J=9/2 |
| 772.97 | 17/2⁻ | | | [314] J=13/2 |

[symbol]

indicates data missing or illegible when filed

### Multi-Channel Calculation of Proton Orbitals

Proton orbitals in Ta-181 are described by Nilsson model

$$\begin{matrix} \hat{H} = - \frac{{h}^{2} {∇}^{2}}{2 {M}_{P}} + V \text{?} ( r , θ ) + V \text{?} ( r , θ ) + \hat{V} \text{?} & ( 56 ) \\ \text{?} \text{indicates text missing or illegible when filed} & \end{matrix}$$

Solve using multi-channel formalism

$$\begin{matrix} Ψ = {\sum }_{\text{?}} {\sum }_{\text{?}} \vert l , m 〉 \vert s , m \text{?} 〉 \frac{P \text{?} ( r )}{r} & ( 57 ) \\ \text{?} \text{indicates text missing or illegible when filed} & \end{matrix}$$

$$\begin{matrix}EP \text{?} ( r ) = [ - \frac{{h}^{2}}{2 M} \frac{{d}^{2}}{{dr}^{2}} + \frac{{h}^{2} l ( l + 1 )}{2 {Mr}^{2}} + 〈 I , m \vert V \vert I , m 〉 ] P \text{?} ( r ) + {\sum }_{\text{?}} 〈 I , m \vert V \vert I \text{?} , m \text{?} 〉 P \text{?} ( r ) & ( 58 ) \\ \text{?} \text{indicates text missing or illegible when filed} & \end{matrix}$$

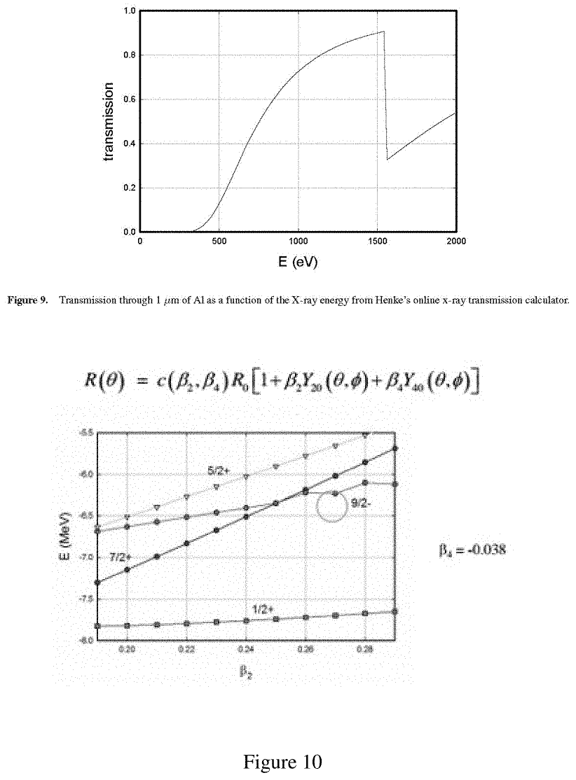

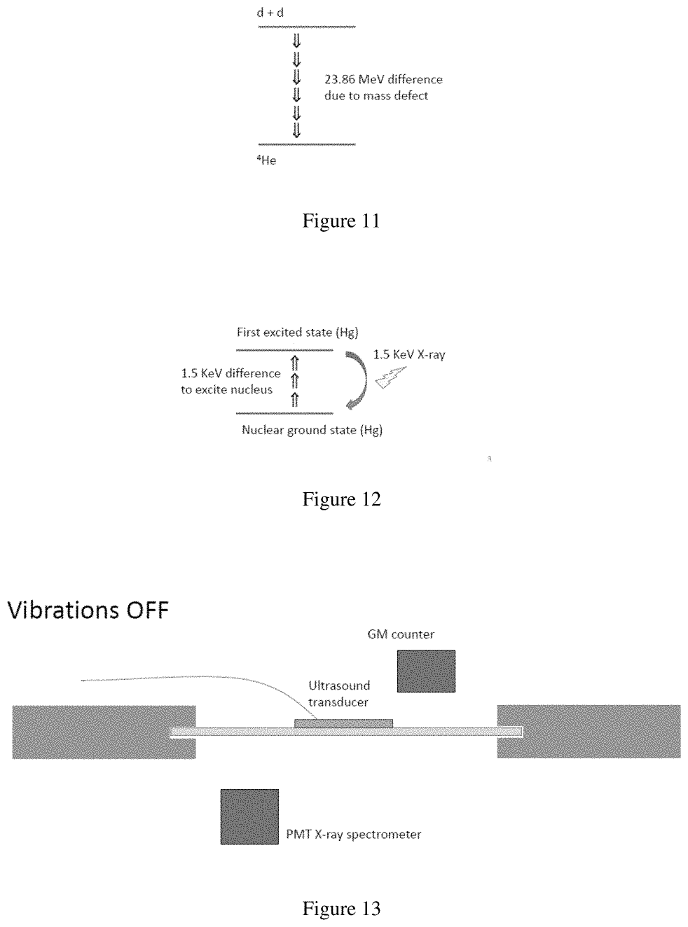

Optimization of the deformed potential is illustrated in FIG. 10.

### Radiative Decay Rate

Radiative decay rate calculated with model

$$\begin{matrix} γ = \frac{4}{3} \text{?} \frac{\text{?}}{4 \text{?}} \frac{\text{?}}{\text{?}} {\vert 〈 \frac{9 \text{?}}{2} \vert \text{?} \vert \frac{\text{?}}{\text{?}} 〉 \vert}^{2} = 3.89 \times 10 \text{?} sec \text{?} & ( 59 ) \\ \text{?} \text{indicates text missing or illegible when filed} & \end{matrix}$$

Experimental number is much slower: 2.37×10³ sec⁻²
Big difference discussed extensively in literature in 1950s, 1960s

Resolution proposed by Nilsson for Ta-181 transition, in part due to accidental interference, in part due to pairing interaction
But we have better models now, and the optimum is not close to where the interference occurs
So, Nilsson explanation not robust (also many other examples of slow radiative decay rates)

### Coupling Matrix Element

Use boosted spin-orbit interaction

$${\hat{H}}_{int} = - i λ \frac{1}{4 {Mmc}^{2}} σ \cdot [ ( \hat{π} U ) \times \hat{P} ] = \hat{a} \cdot c \hat{P} \qquad ( 60 )$$

Magnitude of the a-matrix element computed to be

$$\vert 〈 \frac{{9}^{-}}{2} \vert â \vert \frac{{7}^{+}}{2} 〉 \vert = 1.29 \times {10}^{- 6} \qquad ( 61 )$$

Expect a reduction due to pairing interaction
Even so, matrix element is sufficiently small that Mossbauer splitting in Ta₂ due to this interaction seems unobservable
Would like to check to see how good radiative decay rate is, as test of the nuclear model
   Thoughts about a New Nuclear Model
   Conjecture that care is effective in screening
   Essentially no screening in Nilsson or Hartree-Fock models
   But suppose that the nucleus was closer to a lattice than a quantum gas . . .
   . . . Then isospin exchange could lead to charge mobility in the absence of a strong force restoring force
   This would allow for screening
   Can model with an R|ST type of separation

λ_{R}ψ({r})=(Φ({σ}, {τ})|Ĥ|Φ({σ}, {τ}))ψ({r}) (62)

λ_{ST}Φ({σ}, {τ})=(ψ({r})|Ĥ|ψ({r}))Φ({σ}, {τ}) (63)
Interested in pursuing this kind of model in the future

An experiment occurred with an up-conversion experiment and an excitation transfer experiment. In both experiments, the idea is to couple phonon energy from vibrating metal lattices (steel plates) to nuclear states and achieve nuclear excitation or nuclear excitation transfer. The mechanical excitation happens through ultrasound transducers; the expected measurable outcome is nuclear radiation.

Fleischmann and Pons type experiments: Where does the mass defect energy go? Large mass defect quantum from d+d→⁴He gets down-converted into Millions of sub-eV vibrational quanta.

Karabut; Kornilova and Vysotski experiments: Where does the X-ray energy come from? Thousands of sub-eV vibrational quanta pile up to 1.5 KeV and up-convert individual nuclei. Those emit 1.5 KeV X-rays as they return to ground states.

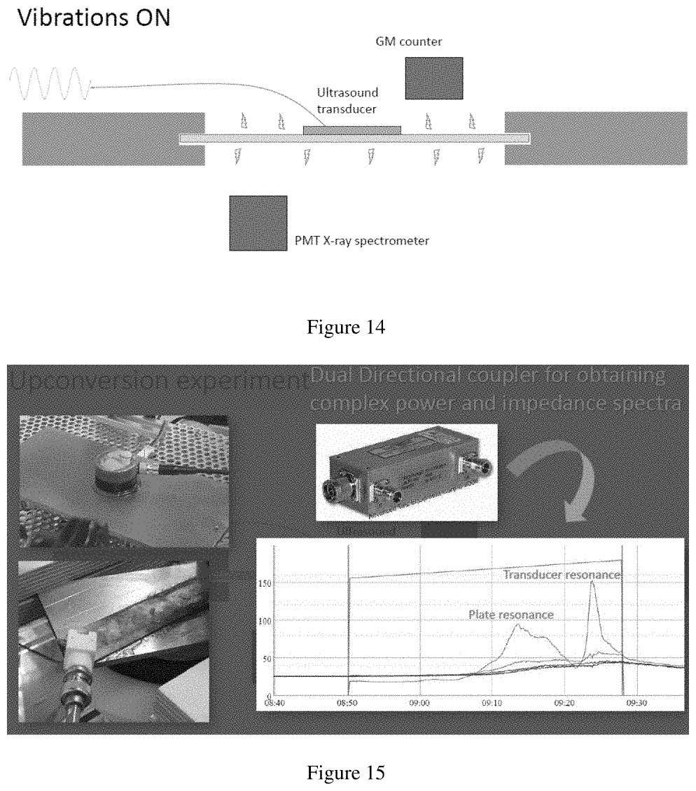

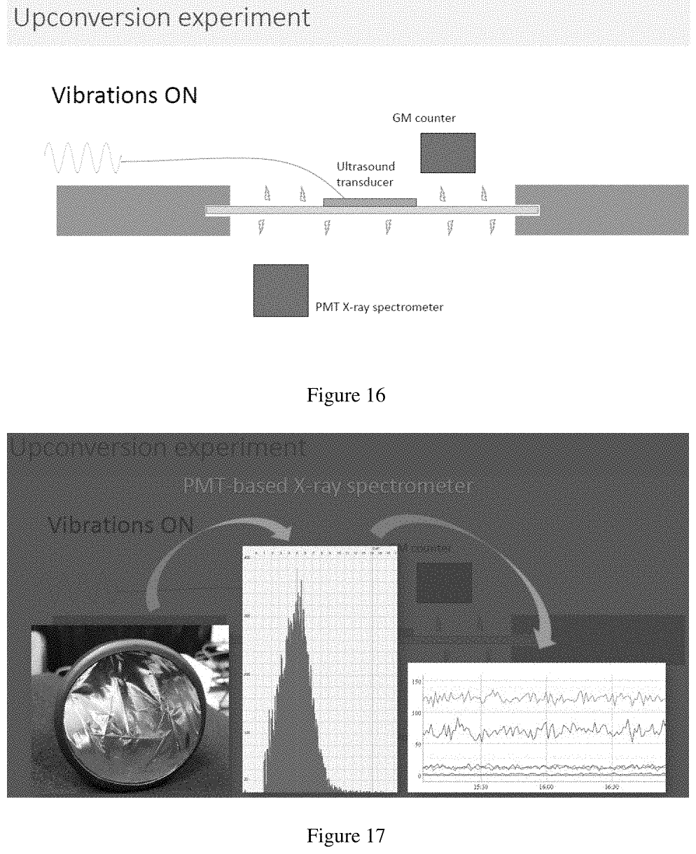

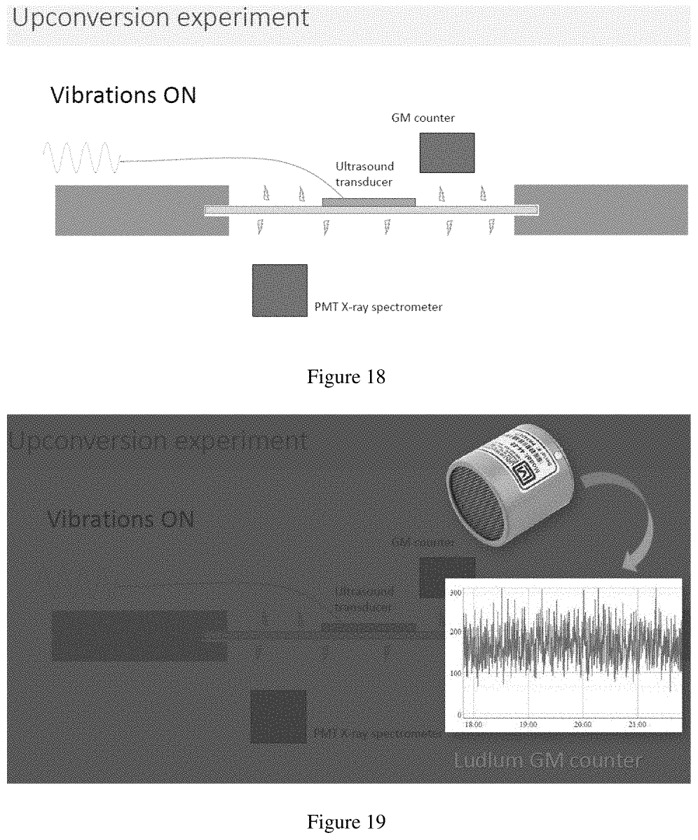

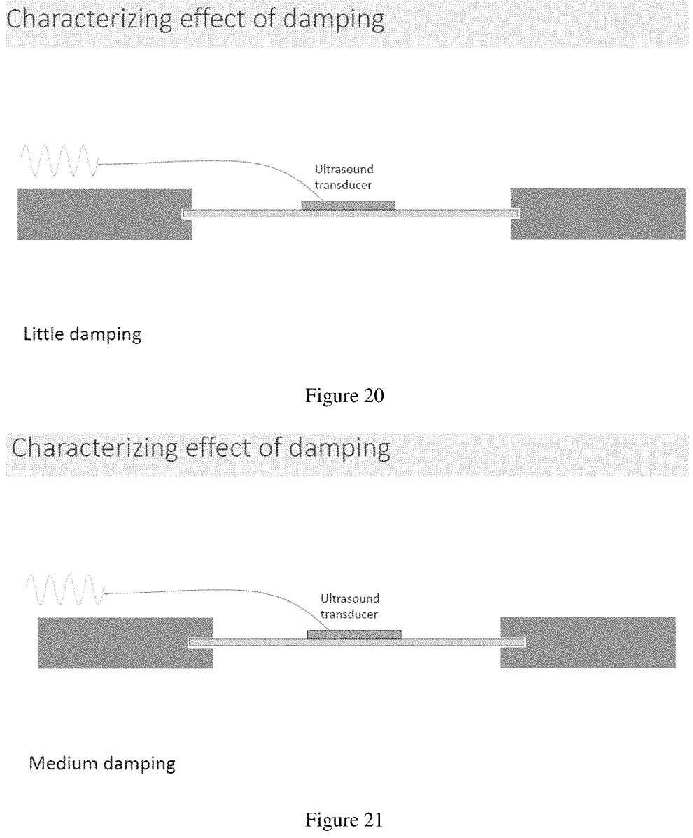

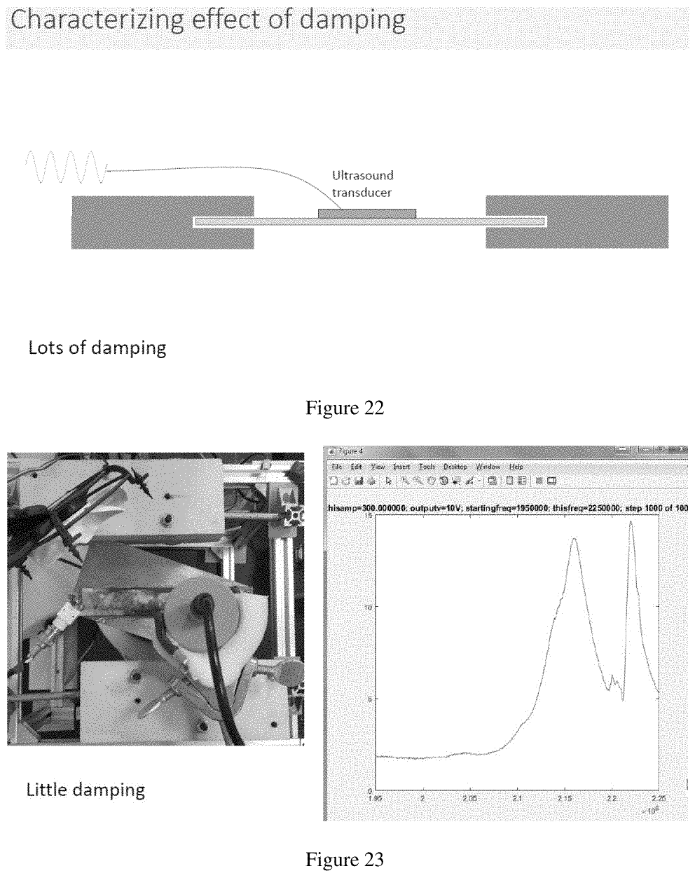

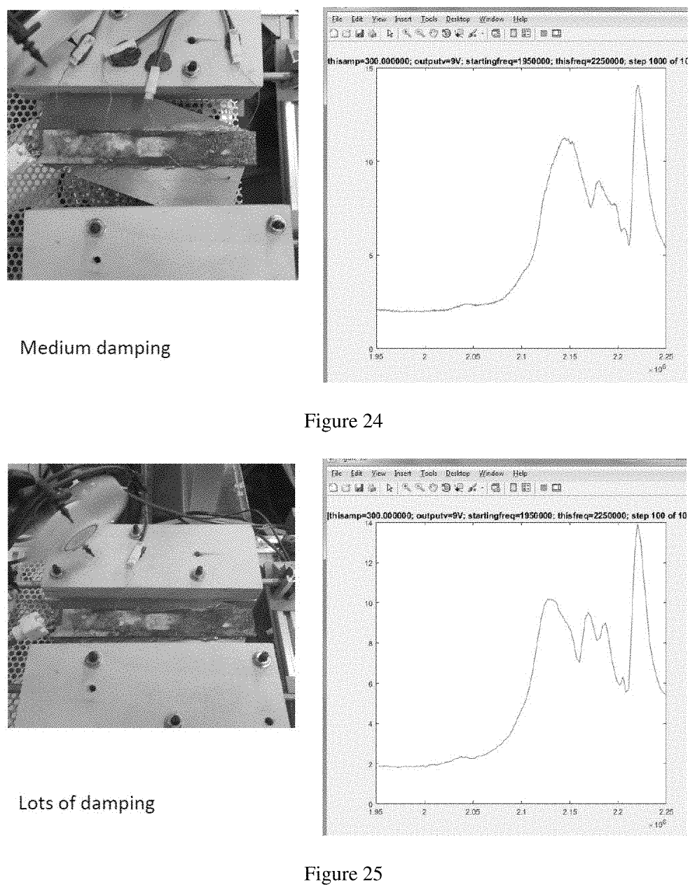

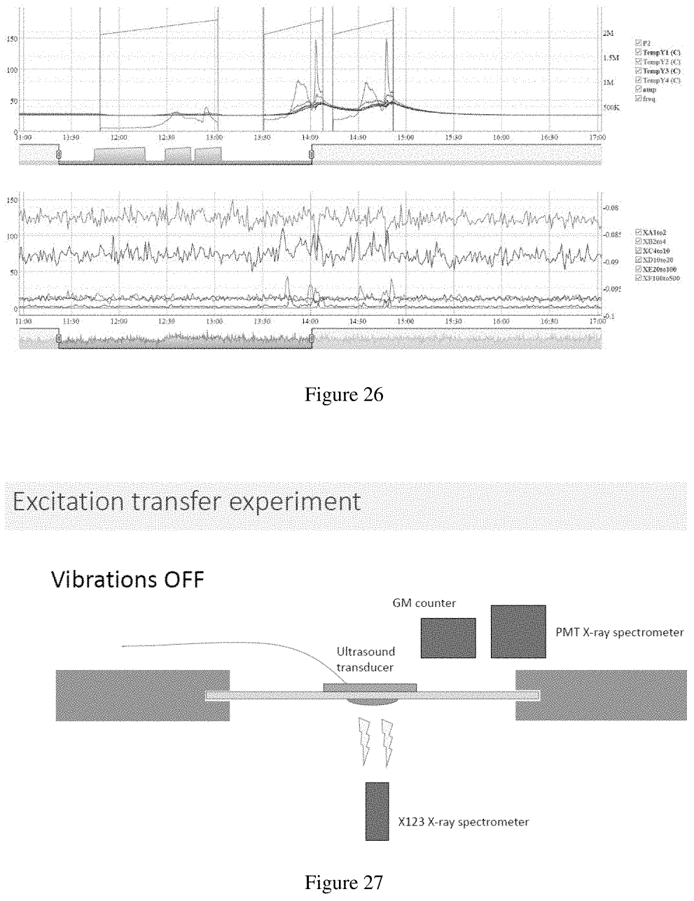

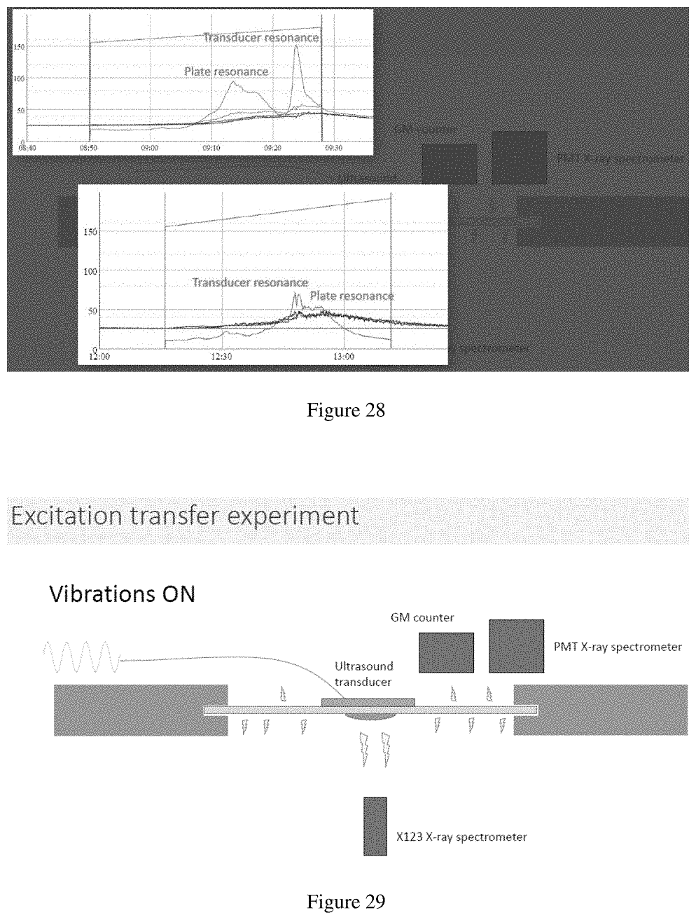

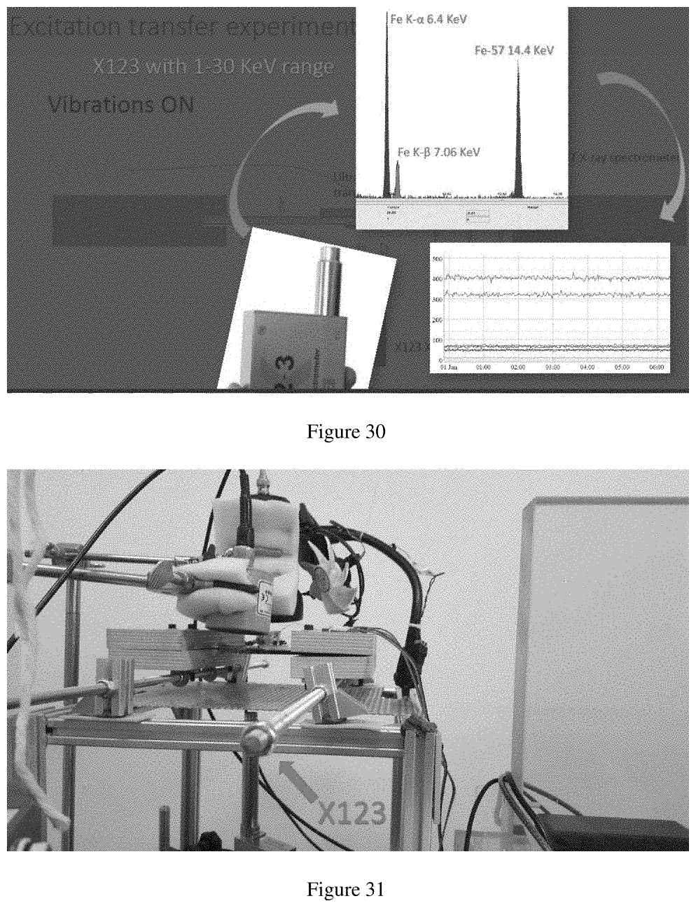

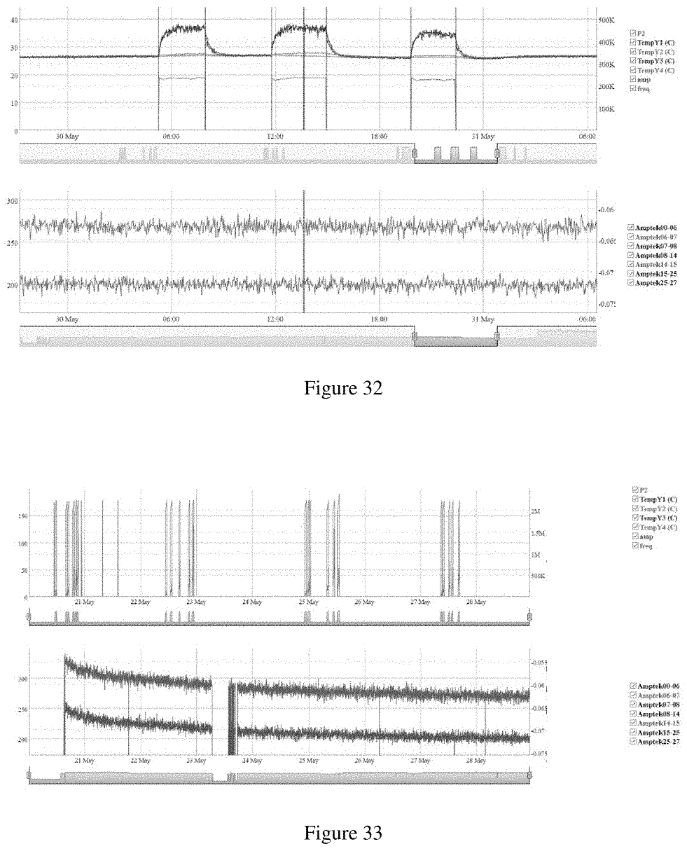

In the experiments, the experimental setup and associated results are illustrated in FIGS. 13 through 26.

Challenges with the proposed experiments:

High power ultrasound (>100 W) leads to certain “false pulses” at the PMT X-ray detector. Possible responses: Reduce mechanical transmission by damping mounting frames, Filter out false pulses in software, and Operate at lower power <100 W

Radfilm window of PMT X-ray detector has poor transmission around 1.5 KeV, one of the regions of interest. Possible responses: Work with a Be window instead that offers better transmission around 1.5 KeV

1.5 KeV emission due to up-conversion is assumed to be caused by small amounts of Hg contamination on the resonators. We do not know whether we have sufficient levels of environmental Hg contamination in our locations/on our samples. Possible responses: We learned how to make Hg Amalgams and add Hg to our samples in a safe way.

Further challenges: cannot currently detect possible excitation transfer emission from backside of plate due to being drowned out from XRF caused by the higher energy Fe-57 radiation passing through the 3 mm plate. Response: repeat the experiment with a thicker plate that blocks the backside of the plate from much of the Fe-57 radiation and minimizes XRF effects.

### Current Status

Carried out initial excitation transfer experiments. Several frequency scans to characterize plate resonance. One run with low power on-off sequence. Based on the preliminary data, we have not observed the predicted excitation transfer effect. Did observe an anomalous decline of Co-57 X-ray peaks.

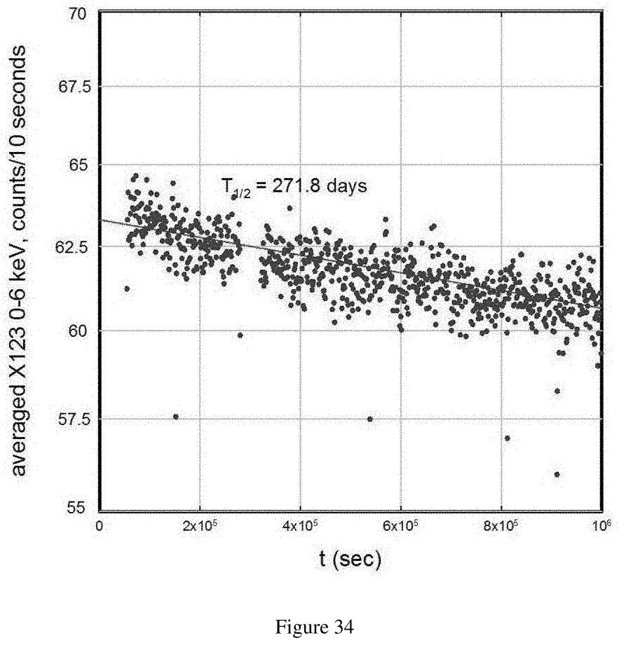

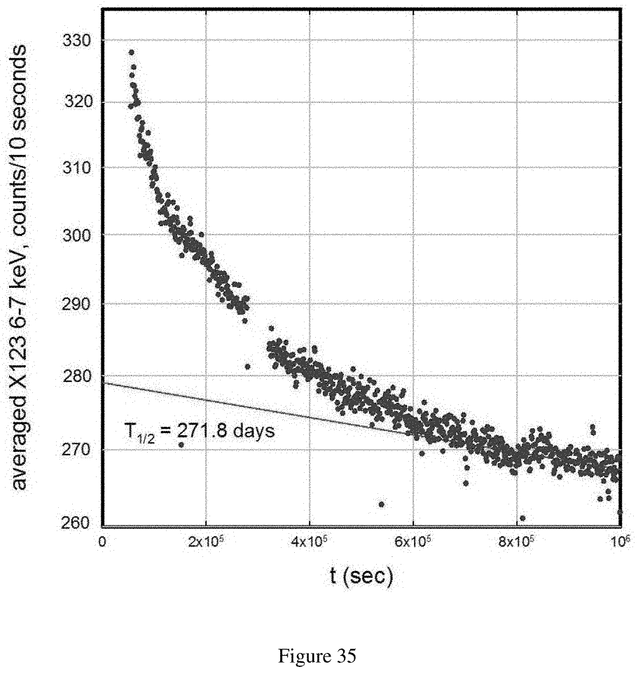

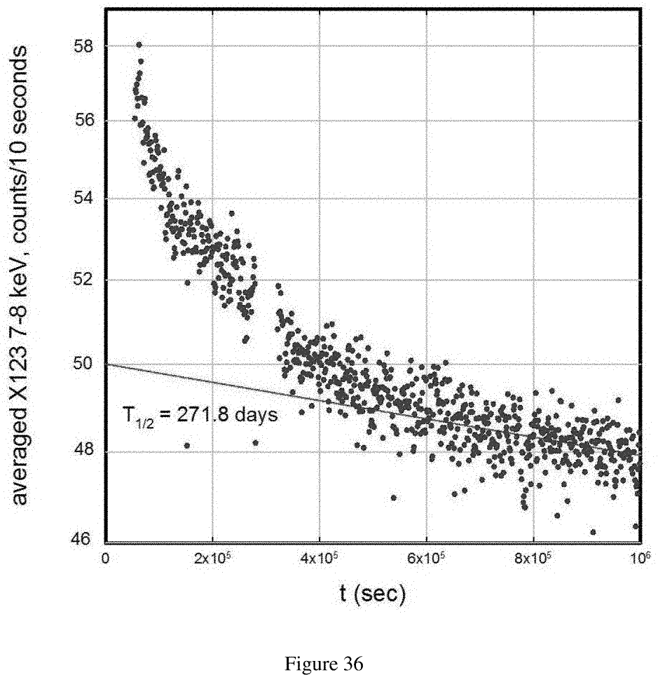

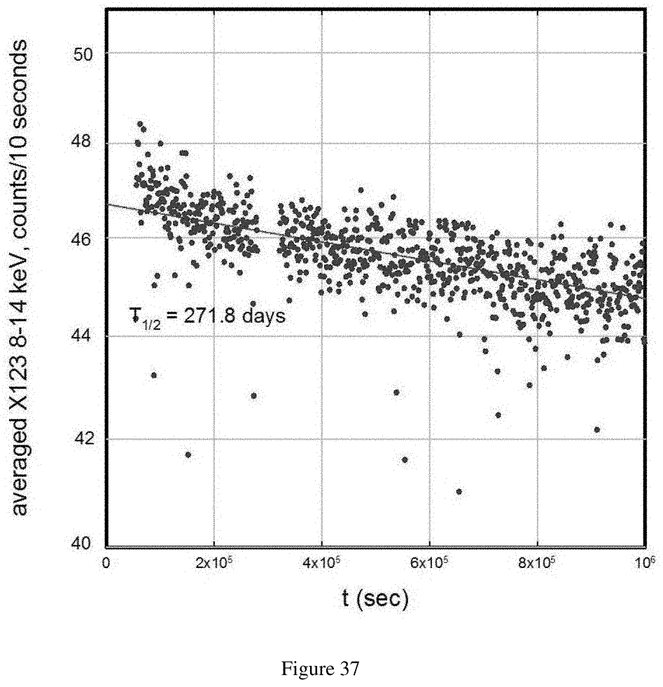

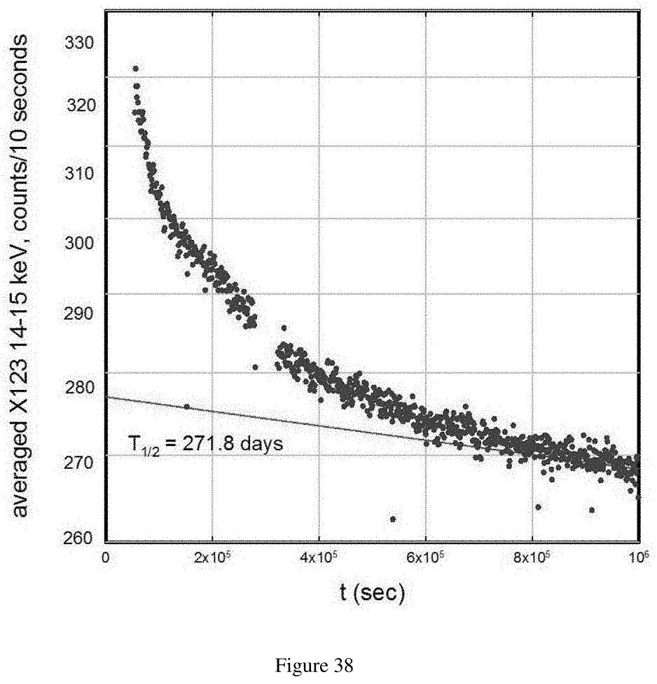

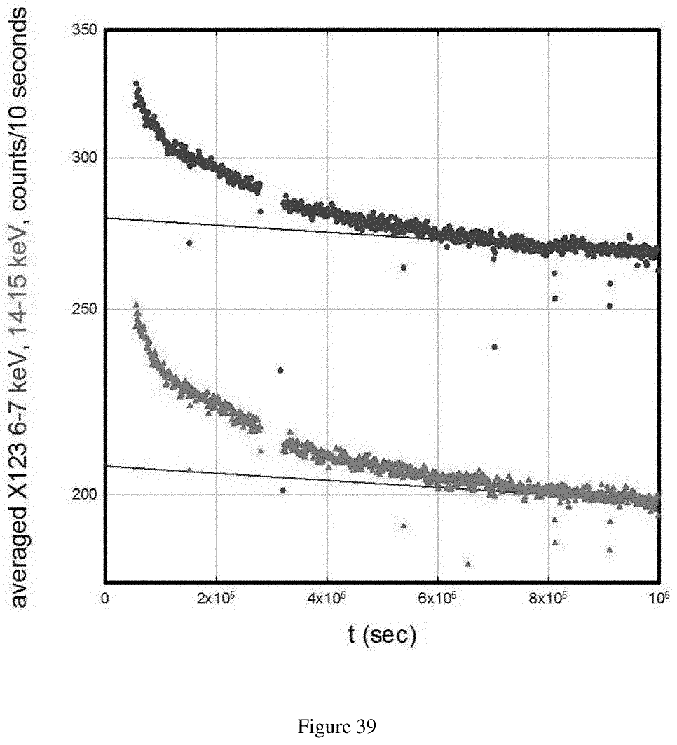

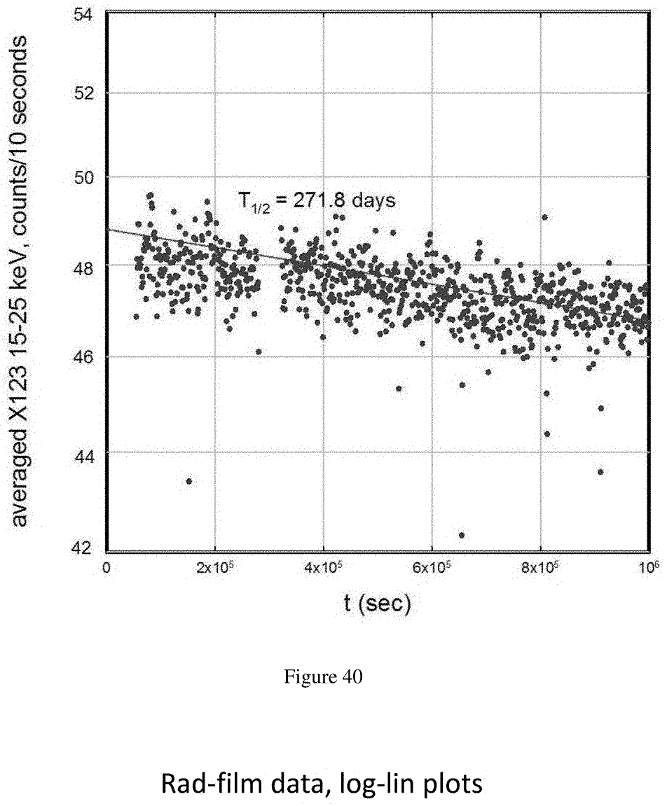

This effect is shown in FIG. 34 and the figures that follow. X-123 data showing clear anomaly. This is faster than exponential decay for Fe Ka, Fe Kb and Fe-57 14.4 keV transition. An observed exponential decay with expected half-life late in run, and exponential decay with expected half-life in 0-6 and 8-14 keV channels. Perhaps deviation from exponential decay in 15-25 keV channel. Enhancement of Fe Ka, Fe Kb and Fe-57 14.4 keV emission at early time.

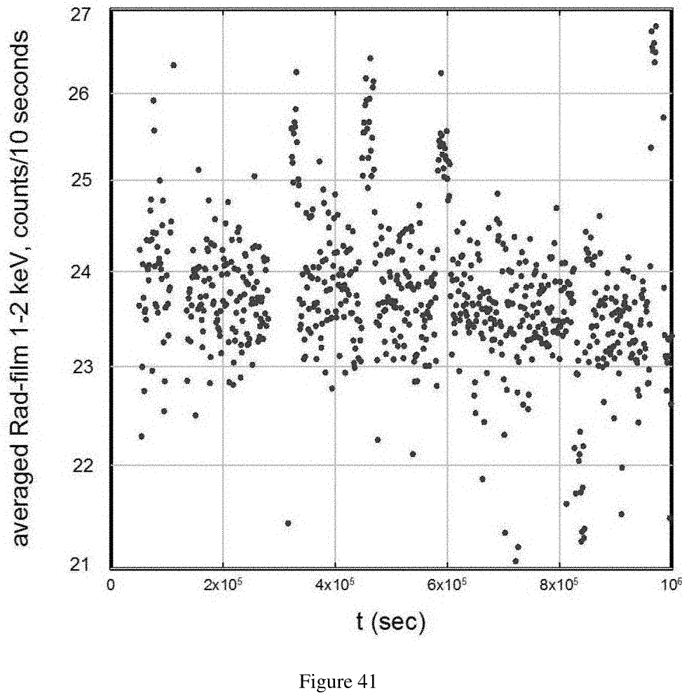

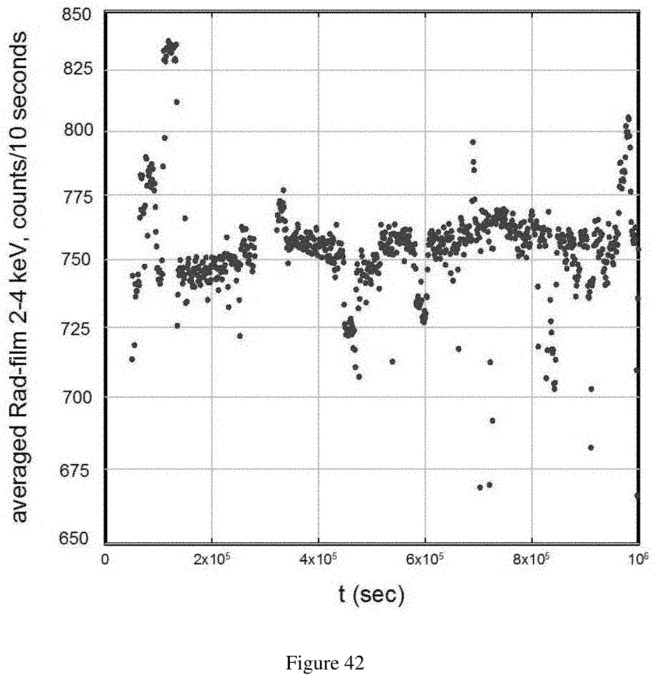

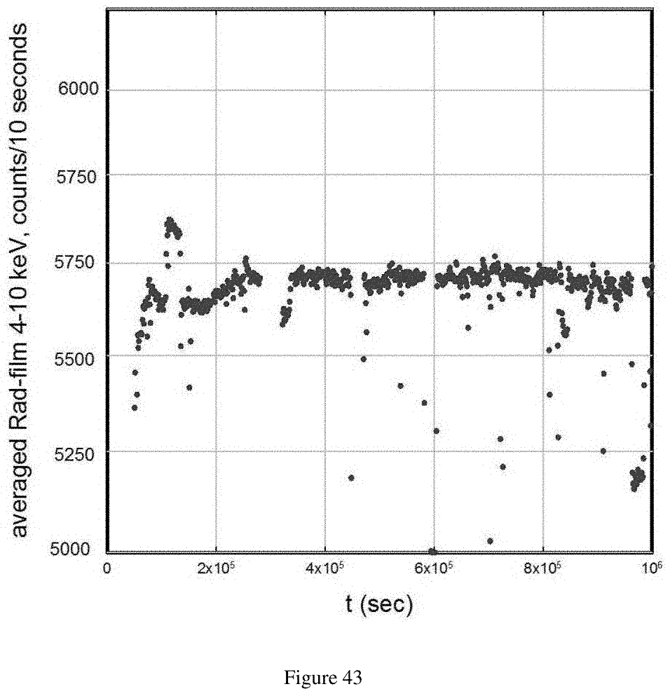

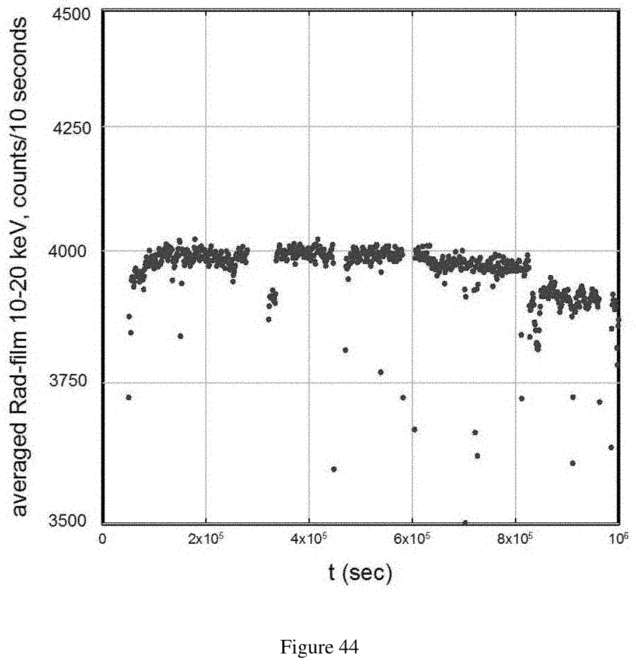

Rad-film data, log-lin plots are illustrated in FIG. 41 and the figures that follow.

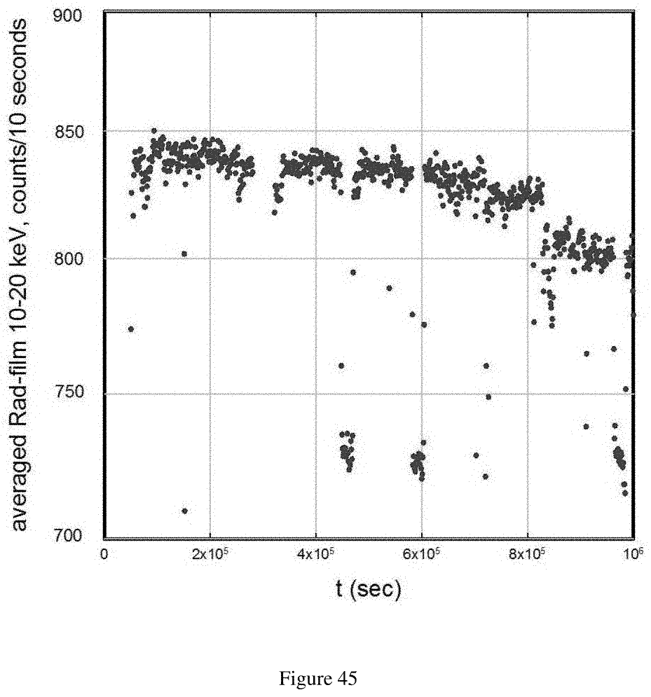

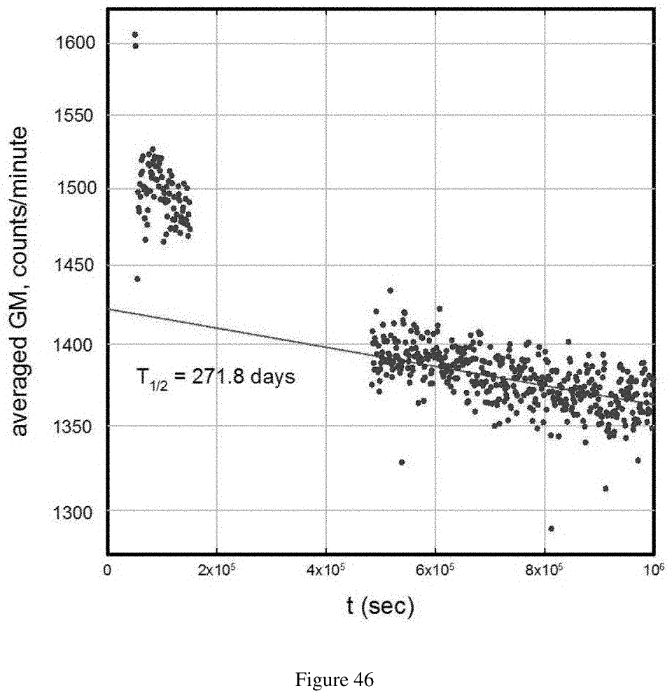

FIG. 45 illustrates rad-film detector looking at the back side. One can see clear dynamics, and non-exponential decay. Event probably not over when experiment interrupted, and perhaps evidence for system responding after 2.25 MHz stimulation.

FIG. 45 details Geiger counter data. Geiger counter looking at the back side; Geiger counter showing exponential decay at late time with expected half-life for Co-57. An observed elevated count rate at early time, that is qualitatively consistent with X-123 effect. May need to re-analyze taking out constant background level near 200.

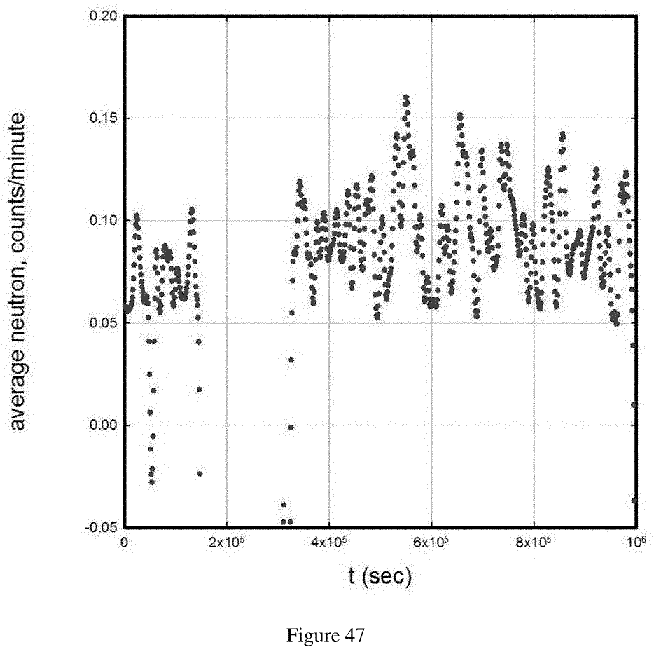

Geiger counter looking at the back side is illustrated in FIG. 47. Geiger counter showing exponential decay at late time with expected half-life for Co-57. There is observed an elevated count rate at early time. This is qualitatively consistent with X-123 effect. Re-analyze taking out constant background level near 200

FIG. 47 illustrates Neutron data, specifically the average neutron counts/minute. The count rate is low, so get significant fluctuations even with averaging. This is probably the neutron emission rate is low early, and higher later

Some Conclusions from these Experiments:

An anomaly may have been observed, non-exponential decay in several channels, with exponential decay with correct half-life in other channels. The GM data seems to support X-123 data. It was originally thought that the rad-film detector was the odd man out, but now proposed that the rad-film detector was detecting anomalous emission that had not finished by the time the experiment was interrupted.

Not Co-57 Loss:

Each day looking at the data set and thinking leads to new ideas and conclusions. Last version was the possibility that we were losing Co-57, however, the channels not looking at resonance lines are going down with T1/2=271.8 days more or less. And late time emission on strong X-123 lines goes down exponentially with half-life consistent with Co-57 decay. This could be interpreted as no anomalous loss of Co-57, however, need to get the gamma detector looking at the experiment to monitor emission at 122 keV.

Excitation transfer is a candidate to account for GM signal on back side. It was expected for excitation transfer to reduce the front side signal, so although possible that we are seeing excitation transfer in the X-123 data I consider this at the moment not to be so likely. Another possibility is observation of up-conversion, though it is also for both up-conversion and excitation transfer. Need further experimentation to clarify, however, since the X-123 detector sees an increase at early time, up-conversion is strongly favored for this part of the anomaly.

Acoustic Versus Optical Phonons.

Vibrational excitation is at 2.25 MHz when stimulation on. X-123 signal not showing a strong response to 2.25 MHz stimulation. Something else probably responsible: current thinking is that optical phonons, and high frequency acoustic phonons, all created during the relaxation of the stressed metal (and wood). Time-dependence in X-123 signal perhaps due to relaxation effect is one possibility. Optical phonons could produce up-conversion. This is consistent with effects seen by Cardone et al, who probably create damaged and stressed metal in vicinity of welding head. Note that Karabut tightens screws in his chamber, and stresses the system when it goes under vacuum

### Applications:

The technology disclosed herein may be advantageously used for a variety of applications and implementations.

The conversion and transfer mechanisms described here can be used to generate collimated X-rays such as low energy X-rays (e.g. below 2 KeV or below 5 KeV) used in X-ray lithography.

One candidate material for this application would be the addition of mercury (specifically Hg-201) to the oscillating medium whose nuclear excited state near 1.5 KeV would allow for the deliberate emission of X-rays in the 1-2 KeV range.

The choice of elements that the medium comprises of can be used to target specific nuclear states that can be occupied/excited through up-conversion, down-conversion, excitation transfer, or subdivision and that lead to photon emission of characteristic energies. That way X-rays/Gamma rays can be generated deliberately within particular desired energy bands. An example: when a nuclear emission source in a particular energy range is desired, one could then consult a table of excited states of isotopes and design an apparatus that gives you the desired emission (e.g. Hg-201 gives you 1.5 KeV; Ta-181 gives you 6.2 KeV; Fe-57 gives you 14.4 KeV).

Moreover, the mechanisms/processes/apparatuses described here allow for the construction of devices where X-radiation (some people call this Gamma radiation since it originates from the nucleus) at various desired energy ranges can be switched on or off at will (this goes for electrons by internal conversion as well). The switching on or off would be achieved via control over the supplied oscillations which in turn can be controlled deliberately e.g. electronically. Applications could include medical applications e.g. when radiation treatments are to be applied internally and only in deliberate, targeted ways once the target zone is reached; or a portable device for short exposure X-ray imaging.

Another application would be a novel way of energy storage: energy could be stored in selected metastable nuclear states of certain materials (most likely materials with long-lived M-4 metastable states e.g. 661 KeV in Ba-137) that could be occupied via up-conversion (and hold the energy for hours, days, months). Energy could then be released/withdrawn from the storage on demand by down-converting from these states.

Another application would be sensors that detect the deformation and relaxation of materials based on the characteristic nuclear excitation changes (up-conversion, down-conversion, excitation transfer, subdivision all based on the choice of medium and sensor design) that are correlated with oscillations resulting from deformation and relaxation of materials.

Another application might be accelerating beta decay e.g. material with unstable nuclei could be pushed up or down into faster lived states through up- or down-conversion and that way nuclear decay could be accelerated.

What is claimed:

1. An apparatus comprising:
a driver for generating oscillations; and
a medium comprising arranged nuclei configured to oscillate at one or more oscillating frequencies when the medium is driven by the driver, wherein (1) nuclear electromagnetic quanta are down-converted to vibrational quanta; or (2) vibrational quanta are up-converted to nuclear quanta; or (3) nuclear excitation is transferred to other nuclei in the medium; or (4) nuclear excitation is subdivided and transferred to other nuclei in the medium (thereby exciting them); or (5) a combination of the above due to interaction between vibrational energy of the oscillating nuclei and the oscillating nuclei.

2. The apparatus of claim 1, wherein the oscillating nuclei comprise stable nuclei that can be excited onto one or more unstable states, and wherein, when the vibrational quanta are up-converted, the vibrational energy excites the stable nuclei to the one or more unstable states from which the excited nuclei undergo nuclear decay.

3. The apparatus of claim 1, wherein, when the vibrational quanta are down-converted, nuclear energy or electrical energy is converted to vibrational energy of the oscillating nuclei.

4. The apparatus of claim 1, wherein some of the oscillating nuclei comprise excited nuclei whose excited states can be transferred to other oscillating nuclei in the medium, thereby elevating them from ground state to excited state while the original excited state nuclei fall to ground state.

5. The claim of claim 4, whereas the excitation transfer from excited nuclei to other nuclei leads to a delocalization of radioactive emission from excited nuclei in the medium.

6. The apparatus of claim 1, wherein some of the oscillating nuclei comprise excited nuclei whose excited state energies are subdivided and transferred to other oscillating nuclei in the medium, thereby elevating them from ground state to excited state while the original excited state nuclei fall to ground state. In this case of subdivision, not the same energy is transferred from one excited nucleus to another nucleus (as with excitation transfer above) but fractions of the excited nucleus' energy are transferred from one excited nucleus to two or more other nuclei (with the sum of the subdivided excitation energy transferred to other nuclei being equal to or smaller than the energy of the originally excited nucleus—and the differential energy being either absorbed or emitted by the lattice as phonons/vibrational energy).

7. The apparatus of claim 1, wherein the oscillations generated by the driver are of one or more driving frequencies between 10 KHz and 50 THz.

8. The apparatus of claim 4, wherein the medium comprises a solid or a liquid and the driver is connected to a signal generator via an amplifier, the signal generator generating a signal of a selected frequency; wherein the signal generator, via the amplifier, applies a drive voltage to the driver and the driver induces oscillations of the nuclei in the medium due to a vibrational coupling.

9. The apparatus of claim 8, wherein the oscillations are generated in other ways as long as (high energy) phonons are being created in the medium such as a transducer setup.

10. The apparatus of claim 8, wherein oscillations are generated through elastic and inelastic deformations or the relaxation of elastic and inelastic deformations such as a press or a clamping mechanism that applies pressure to a medium.

11. The apparatus of claim 10, wherein the clamping mechanism includes wood blocks being pressed against a metal plate which induces stresses on the metal lattice, wherein high frequency phonons are generated during the relaxation of the deformed lattices through both the metal lattice and the wood lattice which is coupled to the metal lattice, wherein the resulting phonons can then cause the described up-conversion, down-conversion, excitation transfer and subdivision effects, as described in any of the preceding claims.

12. The apparatus of claim 8, wherein the selected frequency is set to be one half of a resonant frequency of the metal plate and wherein the resonant frequency of the metal plate is associated with a compressional or transverse vibrational mode of the metal plate.

13. The apparatus of claim 8, wherein the metal plate is further attached to a resonator to arrange for a large number of nuclei to oscillate coherently.

14. The apparatus of claim 8, wherein the metal plate is connected to a collector that collects the charges emitted by the vibrating metal plate.

15. The apparatus of claim 8, wherein the metal plate is made of a metal selected from the group of copper, aluminum, nickel, titanium, palladium, tantalum, and tungsten.

16. The apparatus of claim 8, wherein the driver is connected to a copper pole for support, wherein the length of the driver is between 0.20-0.30 inches and the diameter of the driver is between 0.7-0.8 inches, the thickness of the metal plate is between 70-80 microns, and the distance between the driver and the metal plate is between 10-100 microns.

17. The apparatus of claim 13, wherein the driver is coated with Polyvinylidene Fluoride (PVDF) to prevent air breakdown, and wherein the distance between the driver and the metal plate is approximately 20 microns.

18. The apparatus of claim 1, wherein the oscillating nuclei release phased-array emissions.

19. The apparatus of claim 18, wherein the phased-array emissions are collimated.

20. The apparatus of claim 18, wherein the phased-array emissions comprise X-rays.

21. The apparatus of claim 1, wherein the driver comprises an ultrasound transducer.

22. The apparatus of claim 21, wherein the medium comprises a metal plate where phonon energies from the ultrasound transducer are coupled to excite the oscillating nuclei.

23. A comprising:
oscillating at one or more oscillating frequencies when the medium is driven by the driver, wherein (1) nuclear electromagnetic quanta are down-converted to vibrational quanta; or (2) vibrational quanta are up-converted to nuclear quanta; or (3) nuclear excitation is transferred to other nuclei in the medium; or (4) nuclear excitation is subdivided and transferred to other nuclei in the medium (thereby exciting them); or (5) a combination of the above;—due to interaction between vibrational energy of the oscillating nuclei and the oscillating nuclei.
